(19) United States
(12) Patent Application Publication
(10) Pub. No.: US 2025/0267652 A1
(43) Pub. Date: Aug. 21, 2025

(54) TECHNIQUES FOR DEMODULATION REFERENCE SIGNAL BUNDLING ACROSS UNUSED TRANSMISSION OCCASIONS

(71) Applicant: QUALCOMM Incorporated, San Diego, CA (US)

(72) Inventors: Diana MAAMARI, San Diego, CA (US); Huilin XU, Temecula, CA (US); Ahmed Attia ABOTABL, San Diego, CA (US); Marwen ZORGUI, San Diego, CA (US)

(21) Appl. No.: 18/583,501

(22) Filed: Feb. 21, 2024

(51) Int. Cl. H04W 72/1268; H04L 5/00

(52) U.S. Cl. CPC H04W 72/1268; H04L 5/005

(57) ABSTRACT

Methods, systems, and devices for wireless communications are described that provide for reference signal bundling across two or more uplink transmissions that are transmitted in accordance with an uplink grant configuration of uplink resources for multiple uplink transmission occasions. In the event that a user equipment (UE) does not have data to be transmitted in one of the uplink transmission occasions, the UE may transmit a skipping indication that one or more uplink transmission occasions are to be skipped. A reference signal transmitted with a subsequent uplink transmission after the skipped uplink transmission occasion may be bundled or unbundled with a prior reference signal transmission based on whether the skipped uplink transmission breaks a phase continuity of uplink transmissions, a power consistency of uplink transmissions, or both.

### FIELD OF TECHNOLOGY

The following relates to wireless communications, including techniques for demodulation reference signal bundling across unused transmission occasions.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support techniques for demodulation reference signal bundling across unused transmission occasions. For example, the described techniques provide for reference signal bundling across two or more uplink transmissions that are transmitted in accordance with an uplink grant configuration that provides uplink resources for multiple uplink transmission occasions. In the event that a user equipment (UE) does not have data to be transmitted in one of the uplink transmission occasions, the UE may transmit a skipping indication that one or more uplink transmission occasions are to be skipped. In some cases, a reference signal transmitted with a subsequent uplink transmission after the skipped uplink transmission occasion may be bundled or unbundled with a prior reference signal transmission based on whether the skipped uplink transmission breaks a phase continuity of uplink transmissions, a power consistency of uplink transmissions, or both.

A method for wireless communications by a user equipment (UE) is described. The method may include receiving uplink grant information that provides uplink resources for a set of multiple uplink transmission occasions, where reference signal bundling is enabled across two or more of the set of multiple uplink transmission occasions, transmitting a skipping indication that at least a second uplink transmission occasion of the set of multiple uplink transmission occasions will be unused by the UE, the second uplink transmission occasion subsequent to a first uplink transmission occasion that will be used for an uplink transmission, determining that the second uplink transmission occasion being unused breaks a phase continuity of uplink transmissions, a power consistency of uplink transmissions, or both, across the set of multiple uplink transmission occasions, and transmitting two or more uplink transmissions using at least the first uplink transmission occasion and a third uplink transmission occasion of the set of multiple uplink transmission occasions, where reference signals transmitted in the two or more uplink transmissions are unbundled based on at least the second uplink transmission occasion being unused.

A UE for wireless communications is described. The UE may include one or more memories storing processor executable code, and one or more processors coupled with the one or more memories. The one or more processors may individually or collectively be operable to execute the code to cause the UE to receive uplink grant information that provides uplink resources for a set of multiple uplink transmission occasions, where reference signal bundling is enabled across two or more of the set of multiple uplink transmission occasions, transmit a skipping indication that at least a second uplink transmission occasion of the set of multiple uplink transmission occasions will be unused by the UE, the second uplink transmission occasion subsequent to a first uplink transmission occasion that will be used for an uplink transmission, determine that the second uplink transmission occasion being unused breaks a phase continuity of uplink transmissions, a power consistency of uplink transmissions, or both, across the set of multiple uplink transmission occasions, and transmit two or more uplink transmissions using at least the first uplink transmission occasion and a third uplink transmission occasion of the set of multiple uplink transmission occasions, where reference signals transmitted in the two or more uplink transmissions are unbundled based on at least the second uplink transmission occasion being unused.

Another UE for wireless communications is described. The UE may include means for receiving uplink grant information that provides uplink resources for a set of multiple uplink transmission occasions, where reference signal bundling is enabled across two or more of the set of multiple uplink transmission occasions, means for transmitting a skipping indication that at least a second uplink transmission occasion of the set of multiple uplink transmission occasions will be unused by the UE, the second uplink transmission occasion subsequent to a first uplink transmission occasion that will be used for an uplink transmission, means for determining that the second uplink transmission occasion being unused breaks a phase continuity of uplink transmissions, a power consistency of uplink transmissions, or both, across the set of multiple uplink transmission occasions, and means for transmitting two or more uplink transmissions using at least the first uplink transmission occasion and a third uplink transmission occasion of the set of multiple uplink transmission occasions, where reference signals transmitted in the two or more uplink transmissions are unbundled based on at least the second uplink transmission occasion being unused.

A non-transitory computer-readable medium storing code for wireless communications is described. The code may include instructions executable by one or more processors to receive uplink grant information that provides uplink resources for a set of multiple uplink transmission occasions, where reference signal bundling is enabled across two or more of the set of multiple uplink transmission occasions, transmit a skipping indication that at least a second uplink transmission occasion of the set of multiple uplink transmission occasions will be unused by the UE, the second uplink transmission occasion subsequent to a first uplink transmission occasion that will be used for an uplink transmission, determine that the second uplink transmission occasion being unused breaks a phase continuity of uplink transmissions, a power consistency of uplink transmissions, or both, across the set of multiple uplink transmission occasions, and transmit two or more uplink transmissions using at least the first uplink transmission occasion and a third uplink transmission occasion of the set of multiple uplink transmission occasions, where reference signals transmitted in the two or more uplink transmissions are unbundled based on at least the second uplink transmission occasion being unused.

In some examples of the method, UEs, and non-transitory computer-readable medium described herein, the skipping indication may be included in a set of events that breaks one or more of phase continuity or a power consistency across the set of multiple uplink transmission occasions.

Some examples of the method, UEs, and non-transitory computer-readable medium described herein may further include operations, features, means, or instructions for determining a nominal time domain window for reference signal bundling in which reference signals in two or more of the set of multiple uplink transmission occasions are bundled and restarting the reference signal bundling within an actual time domain window subsequent to the second uplink transmission occasion, the actual time domain window corresponding to a portion of the nominal time domain window.

In some examples of the method, UEs, and non-transitory computer-readable medium described herein, reference signal bundling is not restarted within a nominal time domain window for reference signal bundling in which reference signals in two or more of the set of multiple uplink transmission occasions are bundled.

Some examples of the method, UEs, and non-transitory computer-readable medium described herein may further include operations, features, means, or instructions for determining a nominal time domain window for reference signal bundling in which reference signals in two or more of the set of multiple uplink transmission occasions are bundled, restarting the reference signal bundling within an actual time domain window subsequent to the second uplink transmission occasion when the skipping indication is transmitted prior to a threshold time period in advance of the second uplink transmission occasion, the actual time domain window corresponding to a portion of the nominal time domain window, and determining to not restart the reference signal bundling within the nominal time domain window when the skipping indication is transmitted after the threshold time period in advance of the second uplink transmission occasion.

Some examples of the method, UEs, and non-transitory computer-readable medium described herein may further include operations, features, means, or instructions for transmitting a capability indication that indicates whether the UE is capable of restarting the reference signal bundling subsequent to the skipping indication within a nominal time domain window.

In some examples of the method, UEs, and non-transitory computer-readable medium described herein, the uplink grant information provides periodic uplink resources for a series of time periods, and where two or more uplink transmission occasions are included in each time period of the series of time periods for two or more associated uplink shared channel transmissions according to a multi-grant uplink shared channel transmission configuration. In some examples of the method, UEs, and non-transitory computer-readable medium described herein, the reference signal bundling may be applied to transmit blocks that are transmitted over multiple slots, uplink shared channel transmission repetitions, and uplink shared channel transmissions according to the multi-grant uplink shared channel transmission configuration. In some examples of the method, UEs, and non-transitory computer-readable medium described herein, the reference signal bundling may be applied across two or more different transmit blocks transmitted in two or more of the set of multiple uplink transmission occasions for uplink transmission of the multi-grant uplink shared channel transmission configuration.

A method for wireless communications by a network entity is described. The method may include outputting uplink grant information for a UE, the uplink grant information provides uplink resources for a set of multiple uplink transmission occasions, where reference signal bundling is enabled across two or more of the set of multiple uplink transmission occasions, obtaining a skipping indication that at least a second uplink transmission occasion of the set of multiple uplink transmission occasions will be unused by the UE, the second uplink transmission occasion subsequent to a first uplink transmission occasion that will be used for an uplink transmission, determining that the second uplink transmission occasion being unused breaks one or more of phase continuity or a power consistency across the set of multiple uplink transmission occasions, and obtaining two or more uplink transmissions from the UE using at least the first uplink transmission occasion and a third uplink transmission occasion of the set of multiple uplink transmission occasions, where reference signals transmitted in the two or more uplink transmissions are unbundled based on at least the second uplink transmission occasion being unused.

A network entity for wireless communications is described. The network entity may include one or more memories storing processor executable code, and one or more processors coupled with the one or more memories. The one or more processors may individually or collectively be operable to execute the code to cause the network entity to output uplink grant information for a UE, the uplink grant information provides uplink resources for a set of multiple uplink transmission occasions, where reference signal bundling is enabled across two or more of the set of multiple uplink transmission occasions, obtain a skipping indication that at least a second uplink transmission occasion of the set of multiple uplink transmission occasions will be unused by the UE, the second uplink transmission occasion subsequent to a first uplink transmission occasion that will be used for an uplink transmission, determine that the second uplink transmission occasion being unused breaks one or more of phase continuity or a power consistency across the set of multiple uplink transmission occasions, and obtain two or more uplink transmissions from the UE using at least the first uplink transmission occasion and a third uplink transmission occasion of the set of multiple uplink transmission occasions, where reference signals transmitted in the two or more uplink transmissions are unbundled based on at least the second uplink transmission occasion being unused.

Another network entity for wireless communications is described. The network entity may include means for outputting uplink grant information for a UE, the uplink grant information provides uplink resources for a set of multiple uplink transmission occasions, where reference signal bundling is enabled across two or more of the set of multiple uplink transmission occasions, means for obtaining a skipping indication that at least a second uplink transmission occasion of the set of multiple uplink transmission occasions will be unused by the UE, the second uplink transmission occasion subsequent to a first uplink transmission occasion that will be used for an uplink transmission, means for determining that the second uplink transmission occasion being unused breaks one or more of phase continuity or a power consistency across the set of multiple uplink transmission occasions, and means for obtaining two or more uplink transmissions from the UE using at least the first uplink transmission occasion and a third uplink transmission occasion of the set of multiple uplink transmission occasions, where reference signals transmitted in the two or more uplink transmissions are unbundled based on at least the second uplink transmission occasion being unused.

A non-transitory computer-readable medium storing code for wireless communications is described. The code may include instructions executable by one or more processors to output uplink grant information for a UE, the uplink grant information provides uplink resources for a set of multiple uplink transmission occasions, where reference signal bundling is enabled across two or more of the set of multiple uplink transmission occasions, obtain a skipping indication that at least a second uplink transmission occasion of the set of multiple uplink transmission occasions will be unused by the UE, the second uplink transmission occasion subsequent to a first uplink transmission occasion that will be used for an uplink transmission, determine that the second uplink transmission occasion being unused breaks one or more of phase continuity or a power consistency across the set of multiple uplink transmission occasions, and obtain two or more uplink transmissions from the UE using at least the first uplink transmission occasion and a third uplink transmission occasion of the set of multiple uplink transmission occasions, where reference signals transmitted in the two or more uplink transmissions are unbundled based on at least the second uplink transmission occasion being unused.

In some examples of the method, network entities, and non-transitory computer-readable medium described herein, the skipping indication may be included in a set of events that breaks one or more of phase continuity or a power consistency across the set of multiple uplink transmission occasions.

Some examples of the method, network entities, and non-transitory computer-readable medium described herein may further include operations, features, means, or instructions for determining a nominal time domain window for reference signal bundling in which reference signals in two or more of the set of multiple uplink transmission occasions are bundled and demodulating uplink transmissions according to reference signal bundling when the uplink transmissions is within an actual time domain window subsequent to the second uplink transmission occasion, the actual time domain window corresponding to a portion of the nominal time domain window.

In some examples of the method, network entities, and non-transitory computer-readable medium described herein, reference signal bundling is not restarted within a nominal time domain window for reference signal bundling in which reference signals in two or more of the set of multiple uplink transmission occasions are bundled.

Some examples of the method, network entities, and non-transitory computer-readable medium described herein may further include operations, features, means, or instructions for determining a nominal time domain window for reference signal bundling in which reference signals in two or more of the set of multiple uplink transmission occasions are bundled, demodulating uplink transmissions according to reference signal bundling within an actual time domain window subsequent to the second uplink transmission occasion when the skipping indication is obtained prior to a threshold time period in advance of the second uplink transmission occasion, the actual time domain window corresponding to a portion of the nominal time domain window, and demodulating uplink transmissions according to unbundled reference signals within the nominal time domain window when the skipping indication is obtained after the threshold time period in advance of the second uplink transmission occasion.

Some examples of the method, network entities, and non-transitory computer-readable medium described herein may further include operations, features, means, or instructions for obtaining, from the UE, a capability indication that indicates whether the UE is capable of restarting the reference signal bundling subsequent to the skipping indication within a nominal time domain window.

In some examples of the method, network entities, and non-transitory computer-readable medium described herein, the uplink grant information provides periodic uplink resources for a series of time periods, and where two or more uplink transmission occasions are included in each time period of the series of time periods for two or more associated uplink shared channel transmissions according to a multi-grant uplink shared channel transmission configuration. In some examples of the method, network entities, and non-transitory computer-readable medium described herein, the reference signal bundling may be applied to transmit blocks that are transmitted over multiple slots, uplink shared channel transmission repetitions, and uplink shared channel transmissions according to the multi-grant uplink shared channel transmission configuration. In some examples of the method, network entities, and non-transitory computer-readable medium described herein, the reference signal bundling may be applied across two or more different transmit blocks transmitted in two or more of the set of multiple uplink transmission occasions for uplink transmission of the multi-grant uplink shared channel transmission configuration.

### BRIEF DESCRIPTION OF THE DRAWINGS

FIG. 1 shows an example of a wireless communications system that supports techniques for demodulation reference signal bundling across unused transmission occasions in accordance with one or more aspects of the present disclosure.

FIG. 2 shows an example of a wireless communications system that supports techniques for demodulation reference signal bundling across unused transmission occasions in accordance with one or more aspects of the present disclosure.

FIG. 3 shows an example of skipping indications for configured uplink grants that support techniques for demodulation reference signal bundling across unused transmission occasions in accordance with one or more aspects of the present disclosure.

FIG. 4 shows an example of unused transmission occasion signaling that supports techniques for demodulation reference signal bundling across unused transmission occasions in accordance with one or more aspects of the present disclosure.

FIG. 5 shows an example of a time domain window determination that supports techniques for demodulation reference signal bundling across unused transmission occasions in accordance with one or more aspects of the present disclosure.

FIG. 6 shows an example of a process flow that supports techniques for demodulation reference signal bundling across unused transmission occasions in accordance with one or more aspects of the present disclosure.

FIGS. 7 and 8 show block diagrams of devices that support techniques for demodulation reference signal bundling across unused transmission occasions in accordance with one or more aspects of the present disclosure.

FIG. 9 shows a block diagram of a communications manager that supports techniques for demodulation reference signal bundling across unused transmission occasions in accordance with one or more aspects of the present disclosure.

FIG. 10 shows a diagram of a system including a device that supports techniques for demodulation reference signal bundling across unused transmission occasions in accordance with one or more aspects of the present disclosure.

FIGS. 11 and 12 show block diagrams of devices that support techniques for demodulation reference signal bundling across unused transmission occasions in accordance with one or more aspects of the present disclosure.

FIG. 13 shows a block diagram of a communications manager that supports techniques for demodulation reference signal bundling across unused transmission occasions in accordance with one or more aspects of the present disclosure.

FIG. 14 shows a diagram of a system including a device that supports techniques for demodulation reference signal bundling across unused transmission occasions in accordance with one or more aspects of the present disclosure.

FIGS. 15 through 18 show flowcharts illustrating methods that support techniques for demodulation reference signal bundling across unused transmission occasions in accordance with one or more aspects of the present disclosure.

### DETAILED DESCRIPTION

In some wireless deployments, one or more devices, such as a user equipment (UE) may transmit a series of transmissions to a network device, such as a network entity of a wireless communications network. For example, UE may be a virtual reality or augmented reality device, collectively referred to as XR devices, and may transmit data in bursts over a relatively long period of time (e.g., scene data and related refreshed scene data may be periodically transmitted for a duration of time that a user is using an XR device). In order to reduce overhead associated with such uplink transmissions, a network entity may provide uplink resources for a series of uplink transmission occasions in a configured grant, and the UE may transmit using the uplink resources without a separate uplink grant for each transmission occasion. In order to further enhance system efficiency, in some cases the UE may transmit an indication that one or more uplink transmission occasions are to be skipped by the UE, thus allowing the network to reuse uplink resources that were provided to the UE but that the UE will not use. Further, in some cases reference signal bundling (e.g., demodulation reference signal (DMRS) bundling in which a same of coherent DMRS sequence is transmitted in multiple uplink transmission occasions) may be implemented to enhance channel estimation and provide more reliable decoding of such uplink transmissions.

However, DMRS bundling may require both phase continuity and power consistency among each repetition of the DMRS, and certain events may cause a break in such phase continuity and power consistency such that DMRS bundling may not be used when such an event occurs in a time domain window (TDW) that includes bundled DMRSs. For example, events that may be considered to break phase continuity and power consistency between uplink transmissions may include a change in RB allocation, a change in power or use of different power control parameters, a change in a timing advance value, a beam change, an intervening downlink measurement/monitoring/reception, and/or one or more gaps between transmission greater than 13 symbols (for normal cyclic prefix (CP)). In accordance with various aspects as discussed herein, the events considered to break phase continuity and power consistency between uplink transmissions also may include one or more gaps due to skipped PUSCH occasions (e.g., as indicated by a skipping indication provided in an unused transmission occasion (UTO) uplink control information (UCI) transmission).

In accordance with various aspects, reference signal bundling may be enabled across two or more uplink transmissions that are transmitted in accordance with an uplink grant configuration that provides uplink resources for multiple uplink transmission occasions. In the event that a UE does not have data to be transmitted in one of the uplink transmission occasions, the UE may transmit a skipping indication (e.g., via UTO-UCI) that one or more uplink transmission occasions are to be skipped. In some cases, a reference signal transmitted with a subsequent uplink transmission after the skipped uplink transmission occasion may be bundled or unbundled with a prior reference signal transmission based on whether the skipped uplink transmission breaks a phase continuity of uplink transmissions, a power consistency of uplink transmissions, or both. For example, a UE may provide a skipping indication in UTO-UCI, where the skipping indication is included in a list of events that break phase continuity and power consistency among DMRS repetitions in configured grant (CG) physical uplink shared channel (PUSCH) grants, and therefore result in unbundling of DMRS in PUSCH transmissions within a TDW. In some aspects, in the event that a skipping indication causes DMRS unbundling, a nominal TDW may be broken into two (or more) actual TDWs, and DMRS bundling may be restarted within an actual TDW. In some aspects, a UE may provide a capability indication of whether restarting DMRS bundling within an actual TDW is supported. Additionally, or alternatively, DMRS bundling techniques may be used for multi-grant CG configurations in which each CG period includes two or more UTOs. Further, in some aspects, when multi-grant CG is used, bundling of DMRS may be used when different transport blocks (TBs) are transmitted using the same resource block (RB) and power allocations.

Particular aspects of the subject matter described in this disclosure can be implemented to realize one or more of the following potential advantages. In some implementations, for example, by bundling reference signals channel estimation and decoding at a receiving device may be enhanced, thereby enhancing system efficiency and reliability. Further, in the event one or more uplink transmission occasions are skipped, a skipping indication may allow for a receiving device to avoid trying to decode the associated resources, or reuse the associated resources, thereby enhancing system efficiency. Further, using unbundled reference signals when one or more uplink transmission occasions are skipped may allow for independent decoding and channel estimation of each transmitted reference signal, thereby avoiding attempts to perform joint channel estimation using reference signals that do not have phase continuity or power consistency.

Aspects of the disclosure are initially described in the context of wireless communications systems. Aspects of the disclosure are further illustrated by and described with reference to skipping indications for configured uplink grants, TDW determinations for reference signal bundling, process flows, apparatus diagrams, system diagrams, and flowcharts that relate to techniques for demodulation reference signal bundling across unused transmission occasions.

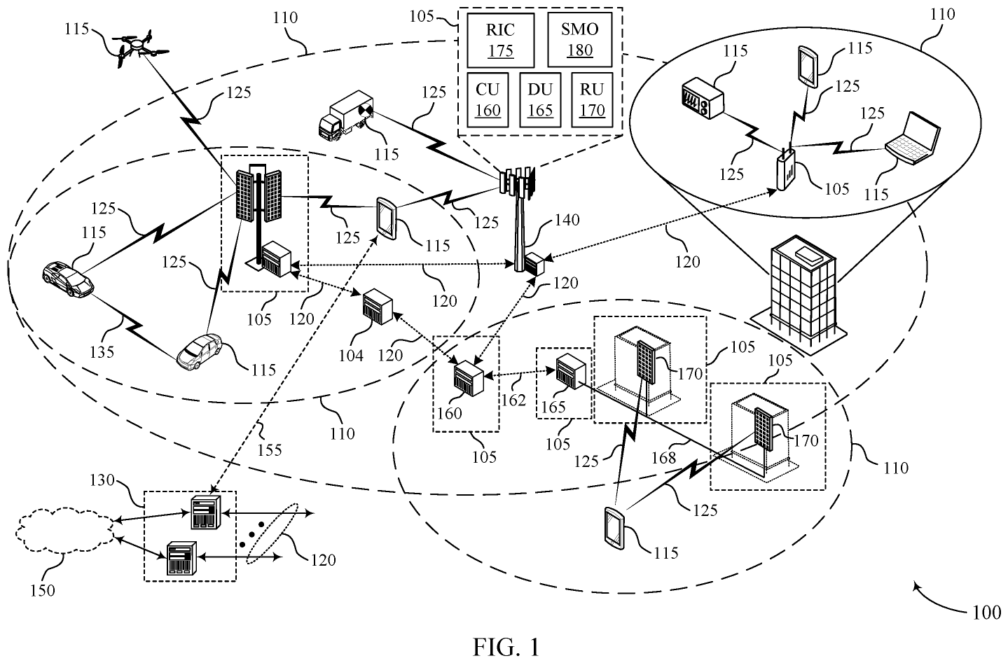

FIG. 1 shows an example of a wireless communications system 100 that supports techniques for demodulation reference signal bundling across unused transmission occasions in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some aspects, a network entity 105 may configure a UE 115 with a set of periodic uplink grant resources, and may enable bundling of reference signals across two or more transmission occasions of the set of periodic uplink grant resources to provide for enhanced channel estimation and more reliable decoding of the associated uplink transmissions. In some cases, in the event that the UE 115 does not have data to be transmitted in one of the uplink transmission occasions, the UE 115 may transmit a skipping indication that one or more uplink transmission occasions are to be skipped. In some cases, a reference signal transmitted with a subsequent uplink transmission after the skipped uplink transmission occasion may be bundled or unbundled with a prior reference signal transmission based on whether the skipped uplink transmission breaks a phase continuity of uplink transmissions, a power consistency of uplink transmissions, or both.

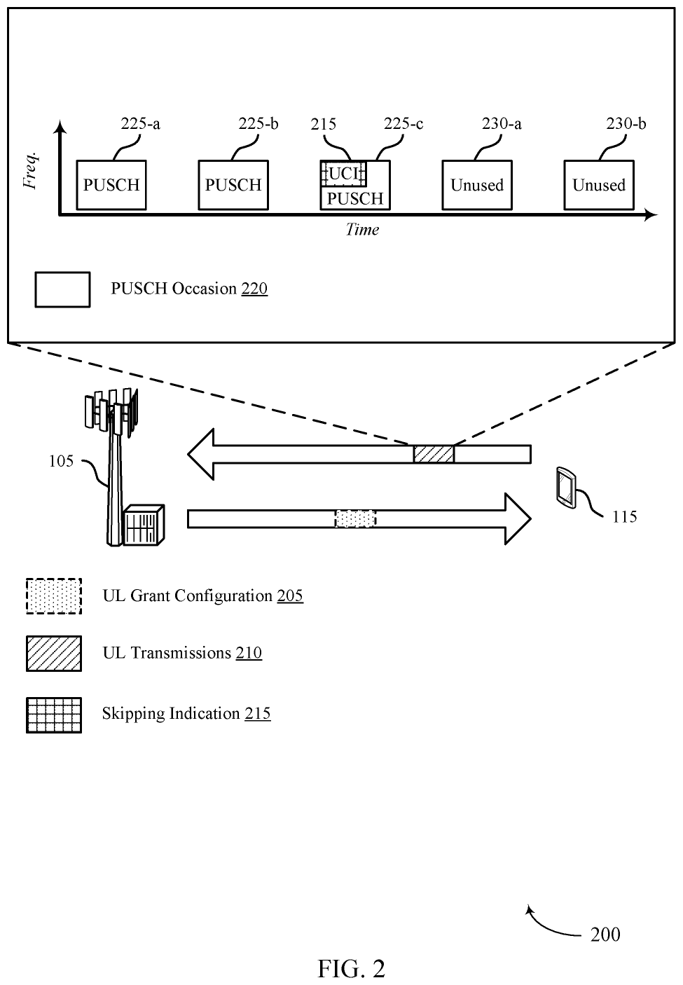

FIG. 2 shows an example of a wireless communications system 200 that supports techniques for demodulation reference signal bundling across unused transmission occasions in accordance with one or more aspects of the present disclosure. The wireless communications system 200 may implement or be implemented by various aspects of the wireless communications system 100. For example, the wireless communications system 200 may include a network entity 105 and a UE 115, which may represent examples of corresponding devices as described with reference to FIG. 1.

The network entity 105 may transmit an uplink grant configuration 205 that provides uplink resources for a series of PUSCH occasions 220. In some aspects, the uplink grant may be a configured grant (CG) that enables reference signal (e.g., DMRS) bundling across multiple PUSCH occasions 220. The UE 115 may transmit one or more uplink transmissions 210 in accordance with the uplink grant configuration 205. In some aspects, the UE 115 may transmit a skipping indication 215 in one or more of the uplink transmissions 210. For example, the UE 115 may transmit a first PUSCH transmission 225-a, a second PUSCH transmission 225-b, and a third PUSCH transmission 225-c in respective PUSCH occasions 220. The third PUSCH transmission 225-c, in this example, may include a skipping indication 215 in UCI (e.g., in a UTO-UCI) that may indicate a first unused transmission occasion 230-a and a second unused transmission occasion 230-b in subsequent PUSCH occasions 220. In accordance with various aspects discussed herein, two or more of the first PUSCH transmission 225-a, the second PUSCH transmission 225-b, and the third PUSCH transmission 225-c may use DMRS bundling in which a DMRS transmitted with each uplink transmission uses a same DMRS sequence or has DMRS coherence, each DMRS has phase continuity, and each DMRS has power consistency (e.g., a same uplink transmit power applied across a same number of antenna ports for a same resource block (RB) allocation). Further, in the event that the skipped uplink transmissions of the first unused transmission occasion 230-a and the second unused transmission occasion 230-b causes a break in the DMRS phase continuity, DMRS has power consistency, or both, a subsequent PUSCH transmission in a subsequent PUSCH occasion 220 may not use DMRS bundling, and the associate DMRS may be transmitted using a DMRS that is independent of the previous DMRS (e.g., that has a different reference signal sequence, different uplink transmit power, or both).

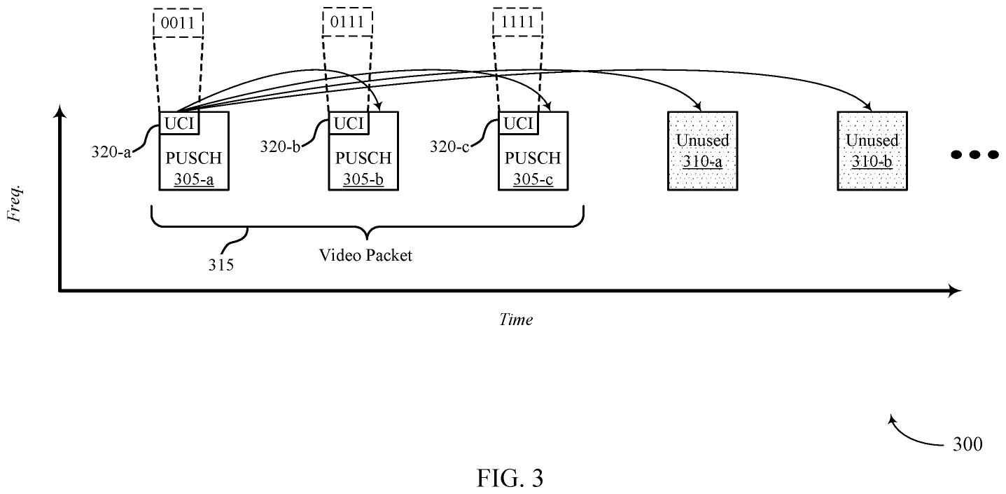

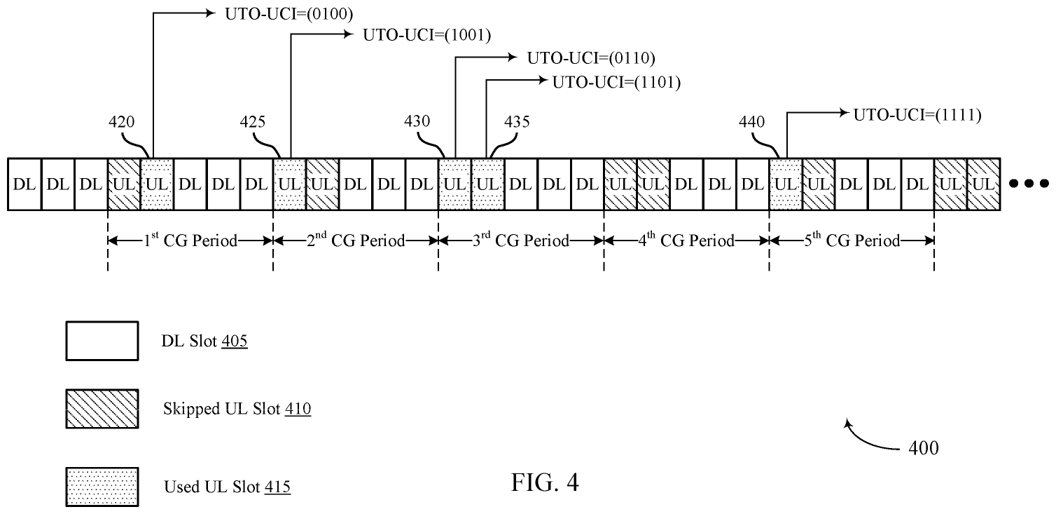

In one example, the UE 115 may transmit frames of XR video using CG PUCSH occasions 220, which may enhance efficiency through avoidance of scheduling request (SR) and buffer status report (BSR) transmissions of dynamic resource requests from the UE 115 and associated downlink control information (DCI) transmissions of the network entity 105 that provides resource assignments. However, unlike voice and uplink control and pose information for XR applications, video packet size may be large and random, and thus the skipping indication 215 may allow flexibility for the network entity 105 to schedule resources to the UE 115 but reuse some resources based on the skipping indication. Examples of skipping indications 215 are discussed in more detail with reference to FIGS. 3 and 4. Such techniques may minimize delay in XR video transfer, while providing for efficient use of resources. In some cases, as discussed in more detail with respect to FIG. 4, each CG period may include two or more CG-PUSCH occasions 220, which may be referred to as multi-CG PUSCH.

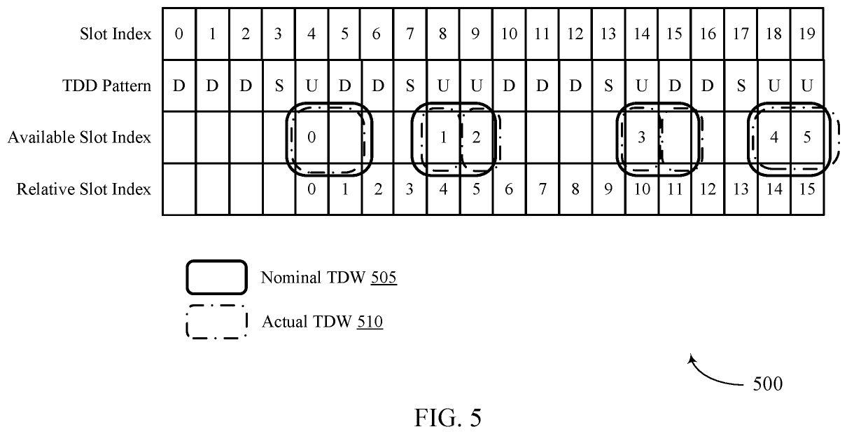

In some cases, DMRS bundling may be used within nominal and actual time domain windows (TDWs), as discussed in more detail with reference to FIG. 5. As discussed herein, when DMRS bundling is enabled, unbundled DMRS may be transmitted when one or more events occur that cause a break in phase continuity and/or power consistency. Such events may include, for example, a change in RB allocation, a change in power or use of different power control parameters, a changed timing advance, a beam change, an intervening downlink measurement/monitoring/reception, one or more gaps between transmissions greater than 13 symbols (for normal CP), or any combinations thereof. In various aspects discussed herein, a skipping indication 215 (e.g., provided in a UTO-UCI) also may cause a break in phase continuity and/or power consistency. In some cases, in the event that a UE 115 encounters an event that breaks phase continuity and/or power consistency, the UE 115 may break a nominal TDW into two or more actual TDWs, as discussed in more detail with reference to FIG. 5.

In some aspects, the UE 115 may provide a capability indication of DMRS bundling, whether the UE 115 is capable of starting or not restarting bundling, or both. In some aspects, DMRS bundling may be supported for multi-CG PUSCH with repetitions. Additionally, techniques as discussed herein may be used in conjunction with one or more of transport block (TB) processing over multi-slot PUSCH (TBOMS), available slot counting, PUSCH repetition type A and type B, or multi-CG PUSCH with repetitions when UTO-UCI indicates skipping. Additionally, or alternatively, when multi-PUSCH CG is used, one or more DMRS bundling restrictions may be removed. Such DMRS bundling restrictions that are removed may include one or more of bundling only being supported across PUSCH/PUCCH repetitions, for Type A repetitions, Type B repetitions (single layer only), and TBOMS; bundling is only applicable to long format PUCCH (e.g., PUCCH format 0 and 2 are precluded); bundling across different TBs is precluded; bundling may be performed only across consecutive slots; or bundling across non-back-to-back PUSCH repetitions is allowed only for gaps less than 14 symbols. In cases where multi-CG PUSCH such restrictions may be removed because within each CG period frequency domain resource assignment (FDRA) and time domain resource assignment (TDRA) are the same for all CG PUSCH transmission occasions even there is no repetition. As a result, DMRS may be transmitted in the same resource pattern, and DMRS bundling may be enabled.

FIG. 3 shows an example of skipping indications for configured uplink grants 300 that supports techniques for demodulation reference signal bundling across unused transmission occasions in accordance with one or more aspects of the present disclosure. The skipping indications for configured uplink grants 300 may implement or be implemented by various aspects of the wireless communications system 100, the wireless communications system 200, or both. For example, the skipping indications for configured uplink grants 300 may represent PUSCH transmission occasions and skipping indication, as shown with reference to FIG. 2.

In this example, a series of transmission occasions may be configured by a CG PUSCH allocation provided to a UE by a network entity, and the UE may transmit a first PUSCH 305-a in a first transmission occasion, a second PUSCH 305-b in a second transmission occasion, and a third PUSCH 305-c in a third PUSCH occasion (e.g., as part of a video packet 315). Each PUSCH transmission 305 may include a UTO-UCI 320 that contains a bitmap with each bit indicating whether a pre-configured CG PUSCH occasion is unused or used. In the example of FIG. 3, the first three transmission occasions are used, and two subsequent transmission occasions 310-a and 310-b are unused. In this example, a first UTO-UCI 320-a may include the bitmap [0011] to indicate the next two consecutive transmission occasions will be used and the two transmission occasions after those will be unused. A second UTO-UCI 320-b may include the bitmap [0111] to indicate the next consecutive transmission occasion will be used and the three transmission occasions afterward will be unused. A third UTO-UCI 320-c may include the bitmap [1111] to indicate the next four consecutive transmission occasions will be unused. In some aspects, UTO-UCI 320 may be contained by a transmitted CG PUSCH and indicates a quantity of future CG PUSCH occasions that corresponds to a number of bits in the bitmap, which may be configured by a network entity (e.g., via RRC signaling). One example of configuration of the UTO-UCI bitmap is described with reference to FIG. 4.

FIG. 4 shows an example of unused transmission occasion signaling 400 that supports techniques for demodulation reference signal bundling across unused transmission occasions in accordance with one or more aspects of the present disclosure. The unused transmission occasion signaling 400 may implement or be implemented by various aspects of the wireless communications system 100, the wireless communications system 200, or both. For example, the unused transmission occasion signaling 400 may represent PUSCH transmission occasions and skipping indication, as shown with reference to FIGS. 2 and 3.

In this example, a UE may be configured with downlink slots 405, and with two uplink slots within each CG period, where the uplink slots may include skipped uplink slots 410 and used uplink slots 415. The UE may be RRC configured with UTO-UCI, where the RRC configuration may indicate a number (Nu) of valid CG-PUSCH occasions in a sliding window, which may be configured by RRC parameter Nu that provides a size of bitmap and may have a value range of 3 to 8, which a minimum of 3 bits to avoid puncturing based multiplexing of UTO-UCI in CG PUSCH. In this example, Nu has a value of four. A transmitted CG PUSCH, carries UTO-UCI that is applicable to the Nu consecutive and valid CG PUSCH transmission occasions, starting with a UTO_offset from the end of the transmitted CG PUSCH. In this example, a first used uplink slot 420 may include UTO-UCI that carries a bitmap [0100] indicates that the UE intends to use the next consecutive CG PUSCH occasion, and skip the CG PUSCH occasion that follows, and not skip the next two CG PUSCH occasions. A second used uplink slot 425 may include UTO-UCI that carries a bitmap [1001] to indicate for the next four uplink slots: skip/use/use/skip. A third used uplink slot 430 may include UTO-UCI that carries a bitmap [0110] to indicate for the next four uplink slots: use/skip/skip/use. A fourth used uplink slot 435 may include UTO-UCI that carries a bitmap [1101] to indicate for the next four uplink slots: skip/skip/use/skip. A fifth used uplink slot 440 may include UTO-UCI that carries a bitmap [1111] to indicate for the next four uplink slots: skip/skip/skip/skip.

FIG. 5 shows an example of a time domain window determination 500 that supports techniques for demodulation reference signal bundling across unused transmission occasions in accordance with one or more aspects of the present disclosure. The time domain window determination 500 may implement or be implemented by various aspects of the wireless communications system 100, the wireless communications system 200, or both. For example, the time domain window determination 500 may represent DMRS bundling that may be used for used CG PUSCH occasions such as shown with reference to FIGS. 2 and 3.

In this example, a set of slots may have slot indices 0 through 19, with each slot configured according to a TDD pattern as a downlink slot, an uplink slot, or a switching slot (between downlink and uplink slots). In some aspects, reference signal bundling (e.g., DMRS bundling) may be configured to be performed for uplink transmissions within a nominal TDW 505, based on available slot counting being enabled. As discussed herein, in some aspects, a skipping indication provided by a UE may break phase continuity, power consistency, or both, across uplink transmission occasions within a nominal TDW 505. In some aspects, the bundling procedure may be broken into two steps. A first step may include a determination of nominal bundles based on a configured nominal TDW duration. Nominal TDWs may start from an available slot and span a certain duration (e.g., nominal TDW duration). A second step may be to bundle within each nominal TDW. If bundling gets interrupted by events that lead to a phase or power change, the nominal TDW may be split, and the UE may restart a new actual TDW 510, and DMRS bundling may be restarted within the new actual TDW 510. In some aspects, nominal TDWs 505 may be broken up into one or more actual TDWs 510. In some aspects, a nominal TDW 505 may be broken up into actual TDWs 510 when the UE can indicate the at least one or more CG-PUSCH occasions are skipped using UTO-UCI. Alternatively, in some aspects, the event that is caused by UTO-UCI skipping PUSCH occasions may be extended through an entire nominal TDW 505, and the UE may not be mandated to restart bundling within the nominal TDW 505. In other aspects, if the skipping is indicated early enough (e.g., at a time offset T from the skipped PUSCH), then the UE may be expected to break the nominal TDW 505 into actual TDWs 510. In other words, the UE is expected to work around the break in phase continuity or power consistency and accommodate for the skipping. However, if the skipping is not indicated early enough (e.g., at a time offset less than T) from the PUSCH to be skipped, then the UE may not be mandated to restart the bundling within the nominal TDW 505.

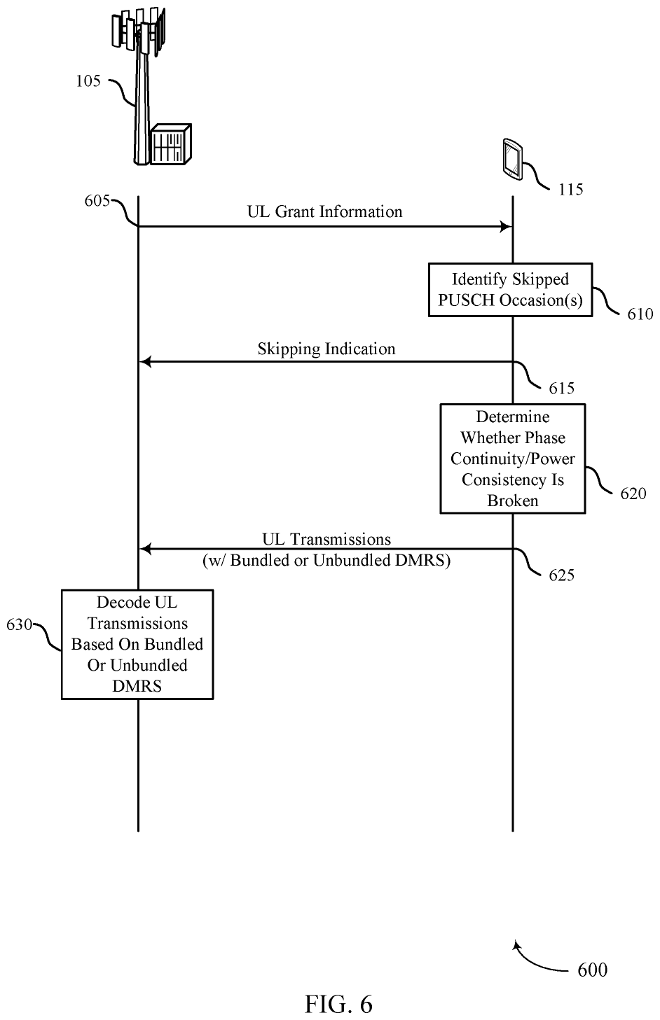

FIG. 6 shows an example of a process flow 600 that supports techniques for demodulation reference signal bundling across unused transmission occasions in accordance with one or more aspects of the present disclosure. In some examples, the process flow 600 may implement or be implemented by aspects of the wireless communications systems 100 or 200 of FIGS. 1 and 2, or systems that implement the skipping indications or TDWs of FIGS. 3 through 5. For example, the process flow 600 may include a network entity 105 and a UE 115, which may be examples of corresponding devices as described with reference to FIGS. 1 and 2.

Alternative examples of the following may be implemented, where some steps are performed in a different order than described or are not performed at all. In some cases, steps may include additional features not mentioned below, or further steps may be added. Although the network entity 105 and the UE 115 are shown performing the operations of the process flow 600, some aspects of some operations may also be performed by one or more other wireless devices (such as by a network entity 105 in accordance with coordination among multiple UEs 115).

At 605, the network entity 105 may transmit, and the UE 115 may receive, uplink grant information. In some aspects, the uplink grant information may provide uplink resources for CG PUSCH transmission occasions, as discussed herein. For example, the uplink grant information may be an example of the uplink grant configuration 205 as described with reference to FIG. 2.

At 610, the UE 115 may identify that one or more PUSCH occasions are to be skipped. As discussed herein, such skipping of PUSCH occasions may be due to the UE 115 not having data to be transmitted in the associated PUSCH occasions, such as due to a video frame having a size that can be accommodated by one or more prior PUSCH occasions.

At 615, the UE 115 may transmit, and the network entity 105 may receive, a skipping indication that indicates one or more PUSCH occasions are to be skipped by the UE 115. In some examples, the skipping indication may provide a bitmap of a set of upcoming PUSCH transmission occasions and whether the UE 115 intends to use of skip each PUSCH transmission occasion of the set of upcoming PUSCH transmission occasions. In some cases, the skipping indication may be an example of skipping indication 215 as described with reference to FIG. 2, an example of UCI 320 as described with reference to FIG. 3, or an example of UTO-UCI as described with reference to FIG. 4.

At 620, the UE 115 may determine whether phase continuity or power consistency is broken by one or more skipped PUSCH occasions. In some aspects, the phase continuity of power consistency may be broken by the skipped PUSCH occasion, and the UE 115 may break a nominal TDW into two or more actual TDWs, with reference signal bundling applied to PUSCH transmissions within an actual TDW.

At 625, the UE 115 may transmit, and the network entity 105 may receive, one or more uplink transmissions with bundled or unbundled reference signals (e.g., DMRS). In cases where the reference signals are unbundled, the UE 115 may independently generate the reference signals, which may be received at the network entity 105 and independently used to provide channel estimation and decoding of received PUSCH transmissions. Likewise, when the reference signals are bundles, the UE may use a same DMRS for each reference signal transmission, and the network entity 105 may combine received DMRSs for enhanced channel estimation and more reliable decoding. At 630, the network entity 105 may decode the uplink transmissions based on the bundled or unbundled reference signals (e.g., DMRSs).

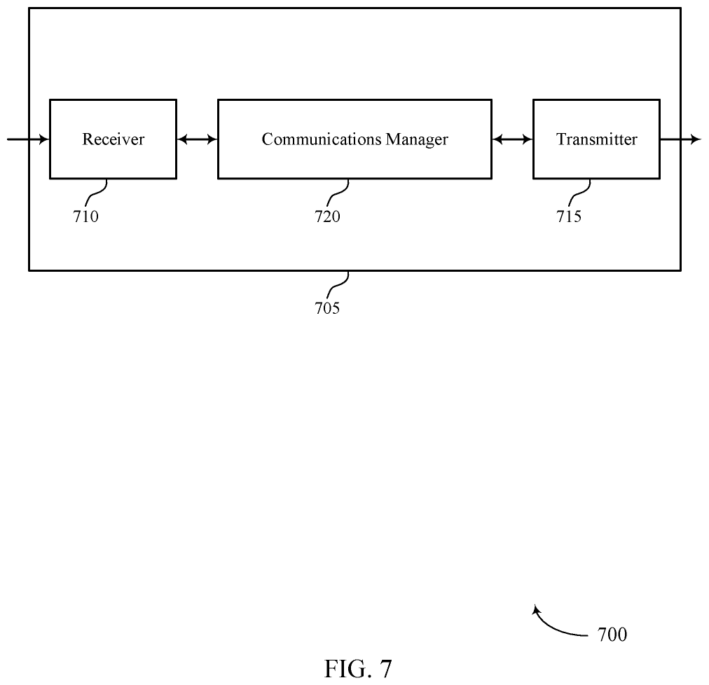

FIG. 7 shows a block diagram 700 of a device 705 that supports techniques for demodulation reference signal bundling across unused transmission occasions in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for demodulation reference signal bundling across unused transmission occasions). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for demodulation reference signal bundling across unused transmission occasions). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of techniques for demodulation reference signal bundling across unused transmission occasions as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for receiving uplink grant information that provides uplink resources for a set of multiple uplink transmission occasions, where reference signal bundling is enabled across two or more of the set of multiple uplink transmission occasions. The communications manager 720 is capable of, configured to, or operable to support a means for transmitting a skipping indication that at least a second uplink transmission occasion of the set of multiple uplink transmission occasions will be unused by the UE, the second uplink transmission occasion subsequent to a first uplink transmission occasion that will be used for an uplink transmission. The communications manager 720 is capable of, configured to, or operable to support a means for determining that the second uplink transmission occasion being unused breaks a phase continuity of uplink transmissions, a power consistency of uplink transmissions, or both, across the set of multiple uplink transmission occasions. The communications manager 720 is capable of, configured to, or operable to support a means for transmitting two or more uplink transmissions using at least the first uplink transmission occasion and a third uplink transmission occasion of the set of multiple uplink transmission occasions, where reference signals transmitted in the two or more uplink transmissions are unbundled based on at least the second uplink transmission occasion being unused.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for bundling of reference signal transmissions, and transmitting unbundled reference signals when a skipped uplink transmission occasion breaks a phase continuity or a power consistency across the plurality of uplink transmission occasions, which may provide for enhanced system efficiency and reliability through more reliable channel estimation and decoding of uplink transmissions, and enhanced efficiency in usage of wireless resources.

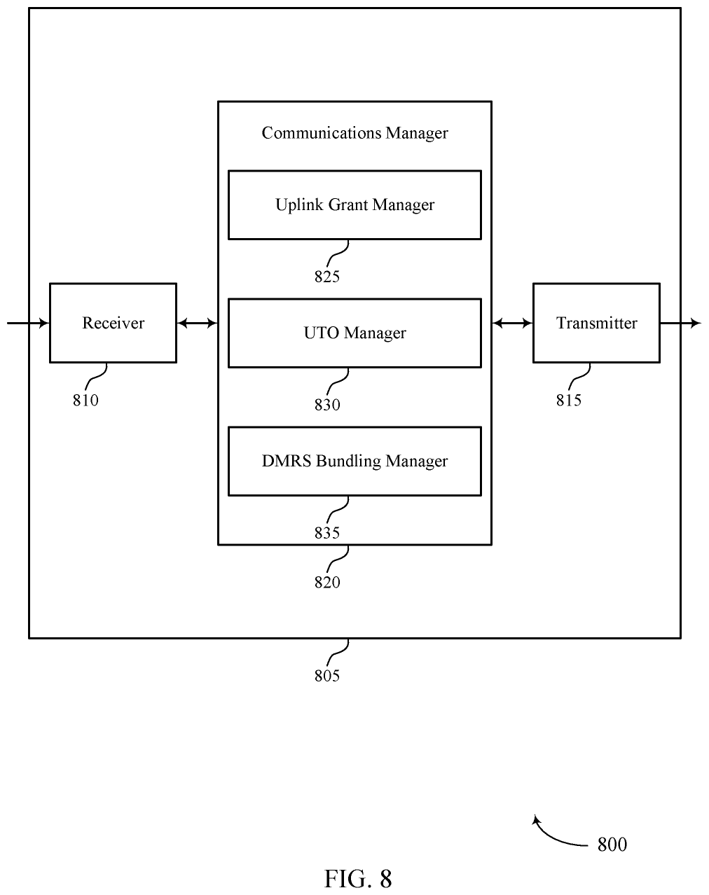

FIG. 8 shows a block diagram 800 of a device 805 that supports techniques for demodulation reference signal bundling across unused transmission occasions in accordance with one or more aspects of the present disclosure. The device 805 may be an example of aspects of a device 705 or a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for demodulation reference signal bundling across unused transmission occasions). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for demodulation reference signal bundling across unused transmission occasions). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of techniques for demodulation reference signal bundling across unused transmission occasions as described herein. For example, the communications manager 820 may include an uplink grant manager 825, a UTO manager 830, a DMRS bundling manager 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The uplink grant manager 825 is capable of, configured to, or operable to support a means for receiving uplink grant information that provides uplink resources for a set of multiple uplink transmission occasions, where reference signal bundling is enabled across two or more of the set of multiple uplink transmission occasions. The UTO manager 830 is capable of, configured to, or operable to support a means for transmitting a skipping indication that at least a second uplink transmission occasion of the set of multiple uplink transmission occasions will be unused by the UE, the second uplink transmission occasion subsequent to a first uplink transmission occasion that will be used for an uplink transmission. The DMRS bundling manager 835 is capable of, configured to, or operable to support a means for determining that the second uplink transmission occasion being unused breaks a phase continuity of uplink transmissions, a power consistency of uplink transmissions, or both, across the set of multiple uplink transmission occasions. The DMRS bundling manager 835 is capable of, configured to, or operable to support a means for transmitting two or more uplink transmissions using at least the first uplink transmission occasion and a third uplink transmission occasion of the set of multiple uplink transmission occasions, where reference signals transmitted in the two or more uplink transmissions are unbundled based on at least the second uplink transmission occasion being unused.

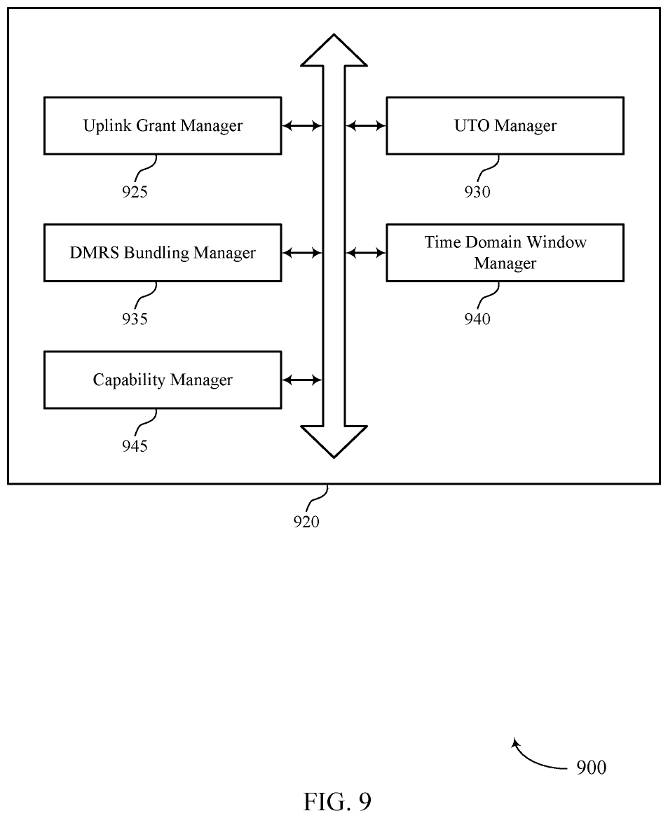

FIG. 9 shows a block diagram 900 of a communications manager 920 that supports techniques for demodulation reference signal bundling across unused transmission occasions in accordance with one or more aspects of the present disclosure. The communications manager 920 may be an example of aspects of a communications manager 720, a communications manager 820, or both, as described herein. The communications manager 920, or various components thereof, may be an example of means for performing various aspects of techniques for demodulation reference signal bundling across unused transmission occasions as described herein. For example, the communications manager 920 may include an uplink grant manager 925, a UTO manager 930, a DMRS bundling manager 935, a time domain window manager 940, a capability manager 945, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The uplink grant manager 925 is capable of, configured to, or operable to support a means for receiving uplink grant information that provides uplink resources for a set of multiple uplink transmission occasions, where reference signal bundling is enabled across two or more of the set of multiple uplink transmission occasions. The UTO manager 930 is capable of, configured to, or operable to support a means for transmitting a skipping indication that at least a second uplink transmission occasion of the set of multiple uplink transmission occasions will be unused by the UE, the second uplink transmission occasion subsequent to a first uplink transmission occasion that will be used for an uplink transmission. The DMRS bundling manager 935 is capable of, configured to, or operable to support a means for determining that the second uplink transmission occasion being unused breaks a phase continuity of uplink transmissions, a power consistency of uplink transmissions, or both, across the set of multiple uplink transmission occasions. In some examples, the DMRS bundling manager 935 is capable of, configured to, or operable to support a means for transmitting two or more uplink transmissions using at least the first uplink transmission occasion and a third uplink transmission occasion of the set of multiple uplink transmission occasions, where reference signals transmitted in the two or more uplink transmissions are unbundled based on at least the second uplink transmission occasion being unused. In some examples, the skipping indication is included in a set of events that breaks one or more of phase continuity or a power consistency across the set of multiple uplink transmission occasions.

In some examples, the time domain window manager 940 is capable of, configured to, or operable to support a means for determining a nominal time domain window for reference signal bundling in which reference signals in two or more of the set of multiple uplink transmission occasions are bundled. In some examples, the time domain window manager 940 is capable of, configured to, or operable to support a means for restarting the reference signal bundling within an actual time domain window subsequent to the second uplink transmission occasion, the actual time domain window corresponding to a portion of the nominal time domain window. In some examples, reference signal bundling is not restarted within a nominal time domain window for reference signal bundling in which reference signals in two or more of the set of multiple uplink transmission occasions are bundled.

In some examples, the time domain window manager 940 is capable of, configured to, or operable to support a means for determining a nominal time domain window for reference signal bundling in which reference signals in two or more of the set of multiple uplink transmission occasions are bundled. In some examples, the time domain window manager 940 is capable of, configured to, or operable to support a means for restarting the reference signal bundling within an actual time domain window subsequent to the second uplink transmission occasion when the skipping indication is transmitted prior to a threshold time period in advance of the second uplink transmission occasion, the actual time domain window corresponding to a portion of the nominal time domain window. In some examples, the time domain window manager 940 is capable of, configured to, or operable to support a means for determining to not restart the reference signal bundling within the nominal time domain window when the skipping indication is transmitted after the threshold time period in advance of the second uplink transmission occasion.

In some examples, the capability manager 945 is capable of, configured to, or operable to support a means for transmitting a capability indication that indicates whether the UE is capable of restarting the reference signal bundling subsequent to the skipping indication within a nominal time domain window. In some examples, the uplink grant information provides periodic uplink resources for a series of time periods, and where two or more uplink transmission occasions are included in each time period of the series of time periods for two or more associated uplink shared channel transmissions according to a multi-grant uplink shared channel transmission configuration. In some examples, the reference signal bundling is applied to transmit blocks that are transmitted over multiple slots, uplink shared channel transmission repetitions, and uplink shared channel transmissions according to the multi-grant uplink shared channel transmission configuration. In some examples, the reference signal bundling is applied across two or more different transmit blocks transmitted in two or more of the set of multiple uplink transmission occasions for uplink transmission of the multi-grant uplink shared channel transmission configuration.

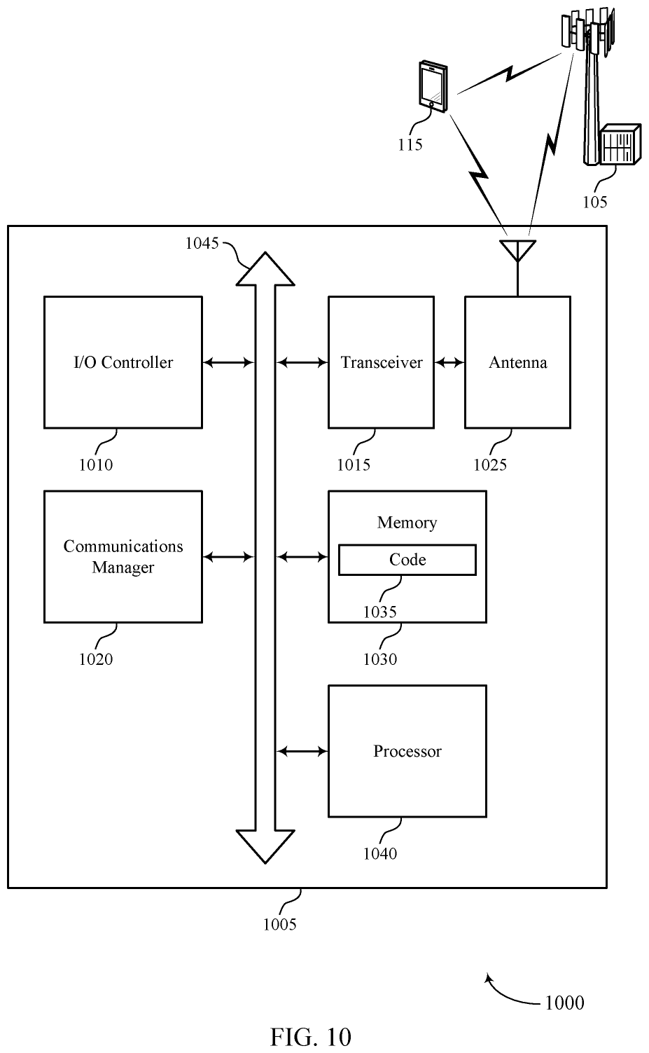

FIG. 10 shows a diagram of a system 1000 including a device 1005 that supports techniques for demodulation reference signal bundling across unused transmission occasions in accordance with one or more aspects of the present disclosure. The device 1005 may be an example of or include components of a device 705, a device 805, or a UE 115 as described herein. The device 1005 may communicate (e.g., wirelessly) with one or more other devices (e.g., network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a basic I/O system (BIOS) which may control basic hardware or software operation such as the interaction with peripheral components or devices.

The at least one processor 1040 may include one or more intelligent hardware devices (e.g., one or more general-purpose processors, one or more DSPs, one or more central processing units (CPUs), one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting techniques for demodulation reference signal bundling across unused transmission occasions). For example, the device 1005 or a component of the device 1005 may include at least one processor 1040 and at least one memory 1030 coupled with or to the at least one processor 1040, the at least one processor 1040 and the at least one memory 1030 configured to perform various functions described herein. In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

The communications manager 1020 may support wireless communications in accordance with examples as disclosed herein. For example, the communications manager 1020 is capable of, configured to, or operable to support a means for receiving uplink grant information that provides uplink resources for a set of multiple uplink transmission occasions, where reference signal bundling is enabled across two or more of the set of multiple uplink transmission occasions. The communications manager 1020 is capable of, configured to, or operable to support a means for transmitting a skipping indication that at least a second uplink transmission occasion of the set of multiple uplink transmission occasions will be unused by the UE, the second uplink transmission occasion subsequent to a first uplink transmission occasion that will be used for an uplink transmission. The communications manager 1020 is capable of, configured to, or operable to support a means for determining that the second uplink transmission occasion being unused breaks a phase continuity of uplink transmissions, a power consistency of uplink transmissions, or both, across the set of multiple uplink transmission occasions. The communications manager 1020 is capable of, configured to, or operable to support a means for transmitting two or more uplink transmissions using at least the first uplink transmission occasion and a third uplink transmission occasion of the set of multiple uplink transmission occasions, where reference signals transmitted in the two or more uplink transmissions are unbundled based on at least the second uplink transmission occasion being unused.

By including or configuring the communications manager 1020 in accordance with examples as described herein, the device 1005 may support techniques for bundling of reference signal transmissions, and transmitting unbundled reference signals when a skipped uplink transmission occasion breaks a phase continuity or a power consistency across the plurality of uplink transmission occasions, which may provide for enhanced system efficiency and reliability through more reliable channel estimation and decoding of uplink transmissions, and enhanced efficiency in usage of wireless resources.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of techniques for demodulation reference signal bundling across unused transmission occasions as described herein, or the at least one processor 1040 and the at least one memory 1030 may be otherwise configured to, individually or collectively, perform or support such operations.

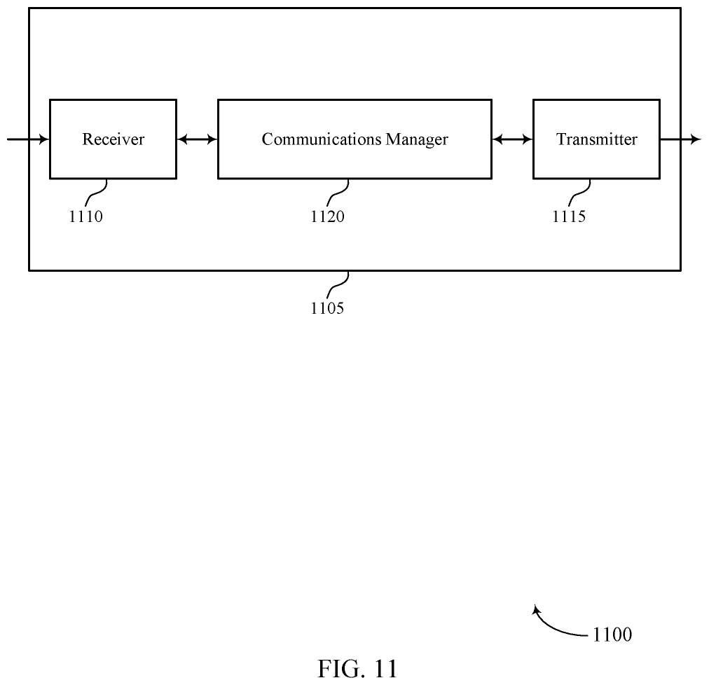

FIG. 11 shows a block diagram 1100 of a device 1105 that supports techniques for demodulation reference signal bundling across unused transmission occasions in accordance with one or more aspects of the present disclosure. The device 1105 may be an example of aspects of a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations or components thereof may be examples of means for performing various aspects of techniques for demodulation reference signal bundling across unused transmission occasions as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor (e.g., referred to as a processor-executable code). If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. For example, the communications manager 1120 is capable of, configured to, or operable to support a means for outputting uplink grant information for a UE, the uplink grant information provides uplink resources for a set of multiple uplink transmission occasions, where reference signal bundling is enabled across two or more of the set of multiple uplink transmission occasions. The communications manager 1120 is capable of, configured to, or operable to support a means for obtaining a skipping indication that at least a second uplink transmission occasion of the set of multiple uplink transmission occasions will be unused by the UE, the second uplink transmission occasion subsequent to a first uplink transmission occasion that will be used for an uplink transmission. The communications manager 1120 is capable of, configured to, or operable to support a means for determining that the second uplink transmission occasion being unused breaks one or more of phase continuity or a power consistency across the set of multiple uplink transmission occasions. The communications manager 1120 is capable of, configured to, or operable to support a means for obtaining two or more uplink transmissions from the UE using at least the first uplink transmission occasion and a third uplink transmission occasion of the set of multiple uplink transmission occasions, where reference signals transmitted in the two or more uplink transmissions are unbundled based on at least the second uplink transmission occasion being unused.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for bundling of reference signal transmissions, and transmitting unbundled reference signals when a skipped uplink transmission occasion breaks a phase continuity or a power consistency across the plurality of uplink transmission occasions, which may provide for enhanced system efficiency and reliability through more reliable channel estimation and decoding of uplink transmissions, and enhanced efficiency in usage of wireless resources.

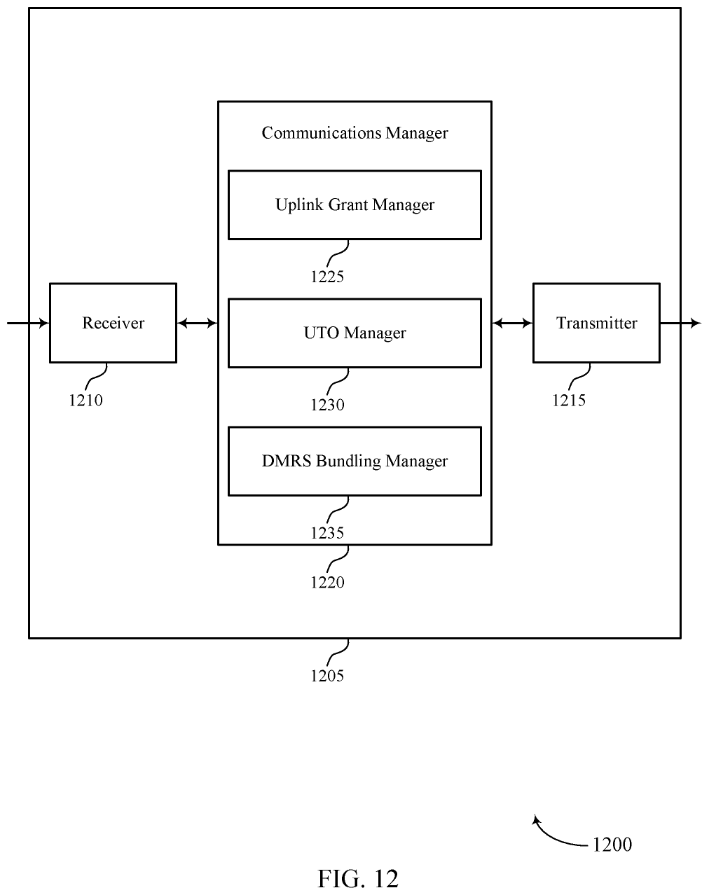

FIG. 12 shows a block diagram 1200 of a device 1205 that supports techniques for demodulation reference signal bundling across unused transmission occasions in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of techniques for demodulation reference signal bundling across unused transmission occasions as described herein. For example, the communications manager 1220 may include an uplink grant manager 1225, a UTO manager 1230, a DMRS bundling manager 1235, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. The uplink grant manager 1225 is capable of, configured to, or operable to support a means for outputting uplink grant information for a UE, the uplink grant information provides uplink resources for a set of multiple uplink transmission occasions, where reference signal bundling is enabled across two or more of the set of multiple uplink transmission occasions. The UTO manager 1230 is capable of, configured to, or operable to support a means for obtaining a skipping indication that at least a second uplink transmission occasion of the set of multiple uplink transmission occasions will be unused by the UE, the second uplink transmission occasion subsequent to a first uplink transmission occasion that will be used for an uplink transmission. The DMRS bundling manager 1235 is capable of, configured to, or operable to support a means for determining that the second uplink transmission occasion being unused breaks one or more of phase continuity or a power consistency across the set of multiple uplink transmission occasions. The DMRS bundling manager 1235 is capable of, configured to, or operable to support a means for obtaining two or more uplink transmissions from the UE using at least the first uplink transmission occasion and a third uplink transmission occasion of the set of multiple uplink transmission occasions, where reference signals transmitted in the two or more uplink transmissions are unbundled based on at least the second uplink transmission occasion being unused.

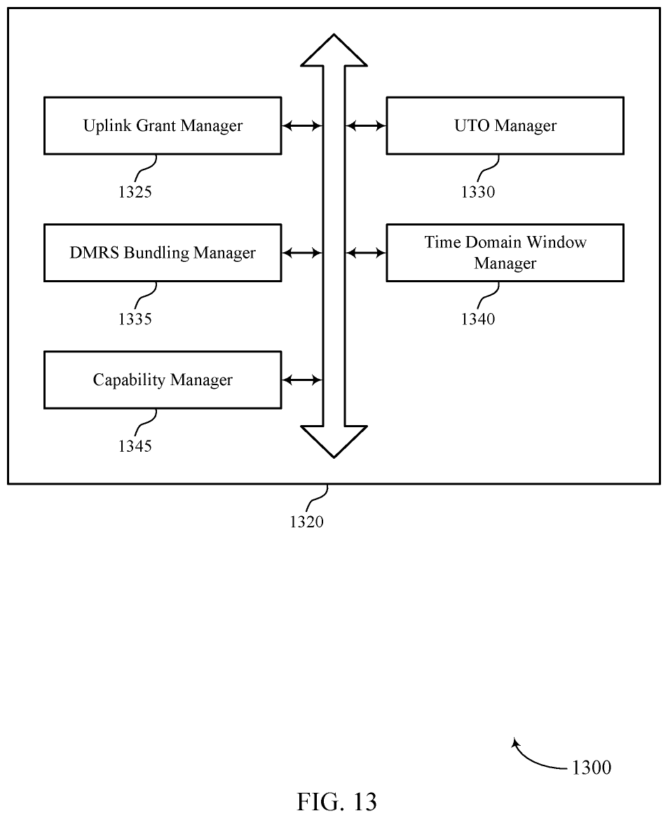

FIG. 13 shows a block diagram 1300 of a communications manager 1320 that supports techniques for demodulation reference signal bundling across unused transmission occasions in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of techniques for demodulation reference signal bundling across unused transmission occasions as described herein. For example, the communications manager 1320 may include an uplink grant manager 1325, a UTO manager 1330, a DMRS bundling manager 1335, a time domain window manager 1340, a capability manager 1345, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communications in accordance with examples as disclosed herein. The uplink grant manager 1325 is capable of, configured to, or operable to support a means for outputting uplink grant information for a UE, the uplink grant information provides uplink resources for a set of multiple uplink transmission occasions, where reference signal bundling is enabled across two or more of the set of multiple uplink transmission occasions. The UTO manager 1330 is capable of, configured to, or operable to support a means for obtaining a skipping indication that at least a second uplink transmission occasion of the set of multiple uplink transmission occasions will be unused by the UE, the second uplink transmission occasion subsequent to a first uplink transmission occasion that will be used for an uplink transmission. The DMRS bundling manager 1335 is capable of, configured to, or operable to support a means for determining that the second uplink transmission occasion being unused breaks one or more of phase continuity or a power consistency across the set of multiple uplink transmission occasions. In some examples, the DMRS bundling manager 1335 is capable of, configured to, or operable to support a means for obtaining two or more uplink transmissions from the UE using at least the first uplink transmission occasion and a third uplink transmission occasion of the set of multiple uplink transmission occasions, where reference signals transmitted in the two or more uplink transmissions are unbundled based on at least the second uplink transmission occasion being unused. In some examples, the skipping indication is included in a set of events that breaks one or more of phase continuity or a power consistency across the set of multiple uplink transmission occasions.

In some examples, the time domain window manager 1340 is capable of, configured to, or operable to support a means for determining a nominal time domain window for reference signal bundling in which reference signals in two or more of the set of multiple uplink transmission occasions are bundled. In some examples, the time domain window manager 1340 is capable of, configured to, or operable to support a means for demodulating uplink transmissions according to reference signal bundling when the uplink transmissions are within an actual time domain window subsequent to the second uplink transmission occasion, the actual time domain window corresponding to a portion of the nominal time domain window. In some examples, reference signal bundling is not restarted within a nominal time domain window for reference signal bundling in which reference signals in two or more of the set of multiple uplink transmission occasions are bundled.

In some examples, the time domain window manager 1340 is capable of, configured to, or operable to support a means for determining a nominal time domain window for reference signal bundling in which reference signals in two or more of the set of multiple uplink transmission occasions are bundled. In some examples, the time domain window manager 1340 is capable of, configured to, or operable to support a means for demodulating uplink transmissions according to reference signal bundling within an actual time domain window subsequent to the second uplink transmission occasion when the skipping indication is obtained prior to a threshold time period in advance of the second uplink transmission occasion, the actual time domain window corresponding to a portion of the nominal time domain window. In some examples, the time domain window manager 1340 is capable of, configured to, or operable to support a means for demodulating uplink transmissions according to unbundled reference signals within the nominal time domain window when the skipping indication is obtained after the threshold time period in advance of the second uplink transmission occasion.

In some examples, the capability manager 1345 is capable of, configured to, or operable to support a means for obtaining, from the UE, a capability indication that indicates whether the UE is capable of restarting the reference signal bundling subsequent to the skipping indication within a nominal time domain window. In some examples, the uplink grant information provides periodic uplink resources for a series of time periods, and where two or more uplink transmission occasions are included in each time period of the series of time periods for two or more associated uplink shared channel transmissions according to a multi-grant uplink shared channel transmission configuration. In some examples, the reference signal bundling is applied to transmit blocks that are transmitted over multiple slots, uplink shared channel transmission repetitions, and uplink shared channel transmissions according to the multi-grant uplink shared channel transmission configuration. In some examples, the reference signal bundling is applied across two or more different transmit blocks transmitted in two or more of the set of multiple uplink transmission occasions for uplink transmission of the multi-grant uplink shared channel transmission configuration.

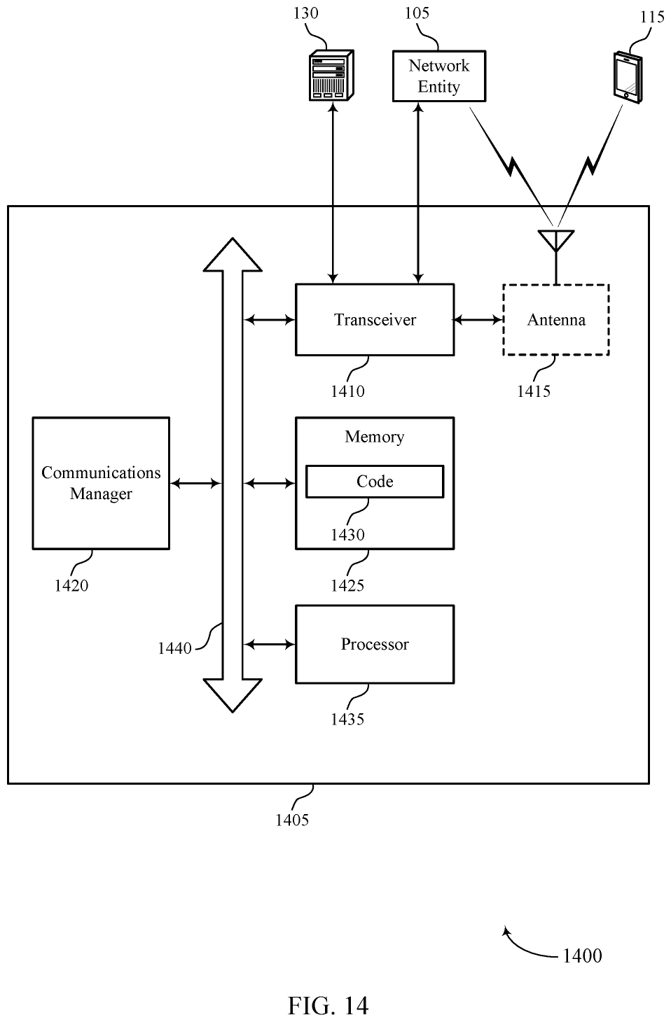

FIG. 14 shows a diagram of a system 1400 including a device 1405 that supports techniques for demodulation reference signal bundling across unused transmission occasions in accordance with one or more aspects of the present disclosure. The device 1405 may be an example of or include components of a device 1105, a device 1205, or a network entity 105 as described herein. The device 1405 may communicate with other network devices or network equipment such as one or more of the network entities 105, UEs 115, or any combination thereof. The communications may include communications over one or more wired interfaces, over one or more wireless interfaces, or any combination thereof. The device 1405 may include components that support outputting and obtaining communications, such as a communications manager 1420, a transceiver 1410, one or more antennas 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., communication link(s) 125, backhaul communication link(s) 120, a midhaul communication link 162, a fronthaul communication link 168).

The at least one memory 1425 may include RAM, ROM, or any combination thereof. The at least one memory 1425 may store computer-readable, computer-executable, or processor-executable code, such as the code 1430. The code 1430 may include instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may include, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include one or more intelligent hardware devices (e.g., one or more general-purpose processors, one or more DSPs, one or more central processing units (CPUs), one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting techniques for demodulation reference signal bundling across unused transmission occasions). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425). In some examples, the at least one processor 1435 may include multiple processors and the at least one memory 1425 may include multiple memories. One or more of the multiple processors may be coupled with one or more of the multiple memories, which may, individually or collectively, be configured to perform various functions herein. In some examples, the at least one processor 1435 may be a component of a processing system, which may refer to a system (such as a series) of machines, circuitry (including, for example, one or both of processor circuitry (which may include the at least one processor 1435) and memory circuitry (which may include the at least one memory 1425)), or components, that receives or obtains inputs and processes the inputs to produce, generate, or obtain a set of outputs. The processing system may be configured to perform one or more of the functions described herein. For example, the at least one processor 1435 or a processing system including the at least one processor 1435 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code stored in the at least one memory 1425 or otherwise, to perform one or more of the functions described herein.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with one or more other network devices 105, and may include a controller or scheduler for controlling communications with UEs 115 (e.g., in cooperation with the one or more other network devices). In some examples, the communications manager 1420 may support an X2 interface within an LTE/LTE-A wireless communications network technology to provide communication between network entities 105.

The communications manager 1420 may support wireless communications in accordance with examples as disclosed herein. For example, the communications manager 1420 is capable of, configured to, or operable to support a means for outputting uplink grant information for a UE, the uplink grant information provides uplink resources for a set of multiple uplink transmission occasions, where reference signal bundling is enabled across two or more of the set of multiple uplink transmission occasions. The communications manager 1420 is capable of, configured to, or operable to support a means for obtaining a skipping indication that at least a second uplink transmission occasion of the set of multiple uplink transmission occasions will be unused by the UE, the second uplink transmission occasion subsequent to a first uplink transmission occasion that will be used for an uplink transmission. The communications manager 1420 is capable of, configured to, or operable to support a means for determining that the second uplink transmission occasion being unused breaks one or more of phase continuity or a power consistency across the set of multiple uplink transmission occasions. The communications manager 1420 is capable of, configured to, or operable to support a means for obtaining two or more uplink transmissions from the UE using at least the first uplink transmission occasion and a third uplink transmission occasion of the set of multiple uplink transmission occasions, where reference signals transmitted in the two or more uplink transmissions are unbundled based on at least the second uplink transmission occasion being unused.

By including or configuring the communications manager 1420 in accordance with examples as described herein, the device 1405 may support techniques for bundling of reference signal transmissions, and transmitting unbundled reference signals when a skipped uplink transmission occasion breaks a phase continuity or a power consistency across the plurality of uplink transmission occasions, which may provide for enhanced system efficiency and reliability through more reliable channel estimation and decoding of uplink transmissions, and enhanced efficiency in usage of wireless resources.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of techniques for demodulation reference signal bundling across unused transmission occasions as described herein, or the at least one processor 1435 and the at least one memory 1425 may be otherwise configured to, individually or collectively, perform or support such operations.

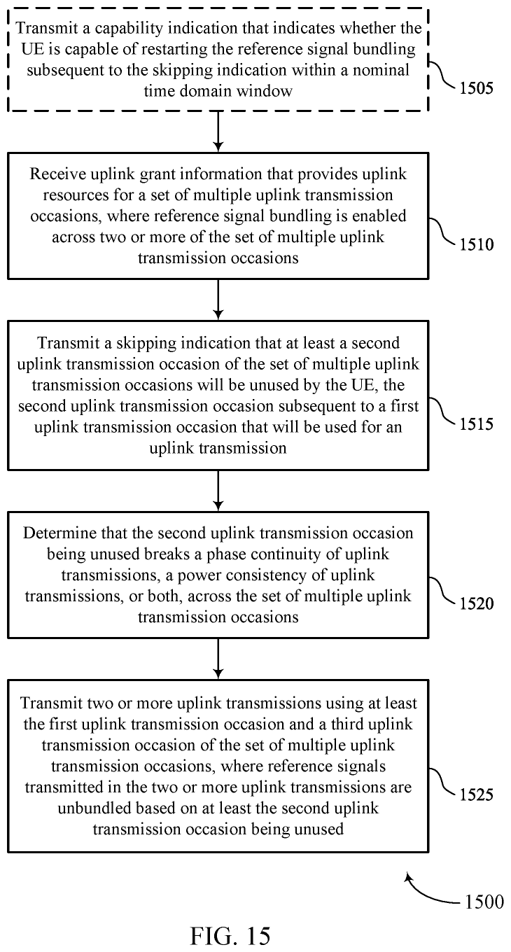

FIG. 15 shows a flowchart illustrating a method 1500 that supports techniques for demodulation reference signal bundling across unused transmission occasions in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

Optionally, at 1505, the method may include transmitting a capability indication that indicates whether the UE is capable of restarting the reference signal bundling subsequent to the skipping indication within a nominal time domain window. The operations of 1505 may be performed in accordance with examples as disclosed herein. In some examples, aspects of the operations of 1505 may be performed by a capability manager 945 as described with reference to FIG. 9.

At 1510, the method may include receiving uplink grant information that provides uplink resources for a set of multiple uplink transmission occasions, where reference signal bundling is enabled across two or more of the set of multiple uplink transmission occasions. The operations of 1510 may be performed in accordance with examples as disclosed herein. In some examples, aspects of the operations of 1510 may be performed by an uplink grant manager 925 as described with reference to FIG. 9.

At 1515, the method may include transmitting a skipping indication that at least a second uplink transmission occasion of the set of multiple uplink transmission occasions will be unused by the UE, the second uplink transmission occasion subsequent to a first uplink transmission occasion that will be used for an uplink transmission. The operations of 1515 may be performed in accordance with examples as disclosed herein. In some examples, aspects of the operations of 1515 may be performed by a UTO manager 930 as described with reference to FIG. 9.

At 1520, the method may include determining that the second uplink transmission occasion being unused breaks a phase continuity of uplink transmissions, a power consistency of uplink transmissions, or both, across the set of multiple uplink transmission occasions. The operations of 1520 may be performed in accordance with examples as disclosed herein. In some examples, aspects of the operations of 1520 may be performed by a DMRS bundling manager 935 as described with reference to FIG. 9.

At 1525, the method may include transmitting two or more uplink transmissions using at least the first uplink transmission occasion and a third uplink transmission occasion of the set of multiple uplink transmission occasions, where reference signals transmitted in the two or more uplink transmissions are unbundled based on at least the second uplink transmission occasion being unused. The operations of 1525 may be performed in accordance with examples as disclosed herein. In some examples, aspects of the operations of 1525 may be performed by a DMRS bundling manager 935 as described with reference to FIG. 9.

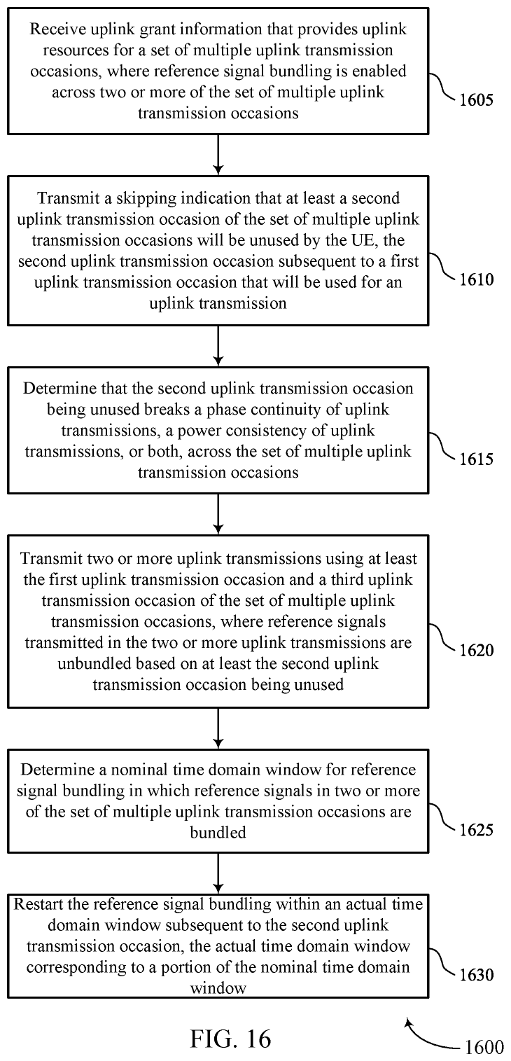

FIG. 16 shows a flowchart illustrating a method 1600 that supports techniques for demodulation reference signal bundling across unused transmission occasions in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include receiving uplink grant information that provides uplink resources for a set of multiple uplink transmission occasions, where reference signal bundling is enabled across two or more of the set of multiple uplink transmission occasions. The operations of 1605 may be performed in accordance with examples as disclosed herein. In some examples, aspects of the operations of 1605 may be performed by an uplink grant manager 925 as described with reference to FIG. 9.

At 1610, the method may include transmitting a skipping indication that at least a second uplink transmission occasion of the set of multiple uplink transmission occasions will be unused by the UE, the second uplink transmission occasion subsequent to a first uplink transmission occasion that will be used for an uplink transmission. The operations of 1610 may be performed in accordance with examples as disclosed herein. In some examples, aspects of the operations of 1610 may be performed by a UTO manager 930 as described with reference to FIG. 9.

At 1615, the method may include determining that the second uplink transmission occasion being unused breaks a phase continuity of uplink transmissions, a power consistency of uplink transmissions, or both, across the set of multiple uplink transmission occasions. The operations of 1615 may be performed in accordance with examples as disclosed herein. In some examples, aspects of the operations of 1615 may be performed by a DMRS bundling manager 935 as described with reference to FIG. 9.

At 1620, the method may include transmitting two or more uplink transmissions using at least the first uplink transmission occasion and a third uplink transmission occasion of the set of multiple uplink transmission occasions, where reference signals transmitted in the two or more uplink transmissions are unbundled based on at least the second uplink transmission occasion being unused. The operations of 1620 may be performed in accordance with examples as disclosed herein. In some examples, aspects of the operations of 1620 may be performed by a DMRS bundling manager 935 as described with reference to FIG. 9.

At 1625, the method may include determining a nominal time domain window for reference signal bundling in which reference signals in two or more of the set of multiple uplink transmission occasions are bundled. The operations of 1625 may be performed in accordance with examples as disclosed herein. In some examples, aspects of the operations of 1625 may be performed by a time domain window manager 940 as described with reference to FIG. 9.

At 1630, the method may include restarting the reference signal bundling within an actual time domain window subsequent to the second uplink transmission occasion, the actual time domain window corresponding to a portion of the nominal time domain window. The operations of 1630 may be performed in accordance with examples as disclosed herein. In some examples, aspects of the operations of 1630 may be performed by a time domain window manager 940 as described with reference to FIG. 9.

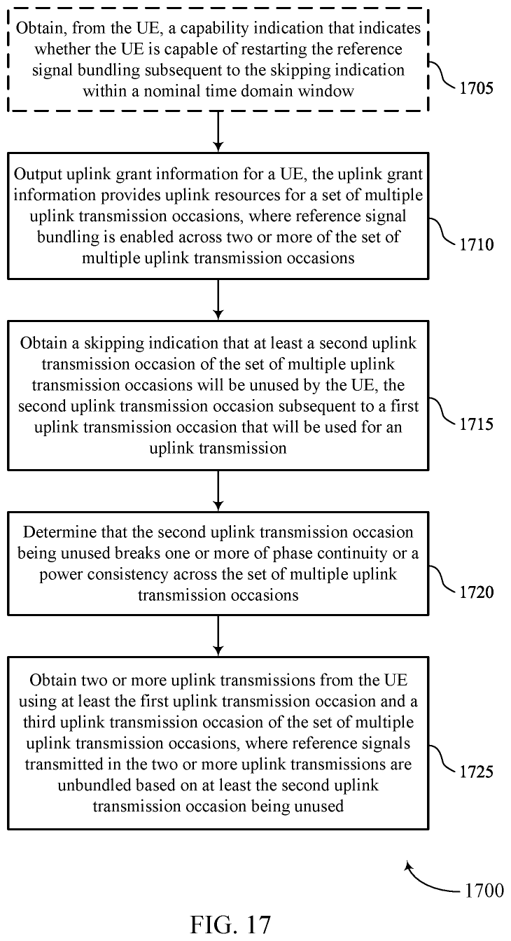

FIG. 17 shows a flowchart illustrating a method 1700 that supports techniques for demodulation reference signal bundling across unused transmission occasions in accordance with one or more aspects of the present disclosure. The operations of the method 1700 may be implemented by a network entity or its components as described herein. For example, the operations of the method 1700 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

Optionally, at 1705, the method may include obtaining, from the UE, a capability indication that indicates whether the UE is capable of restarting the reference signal bundling subsequent to the skipping indication within a nominal time domain window. The operations of 1705 may be performed in accordance with examples as disclosed herein. In some examples, aspects of the operations of 1705 may be performed by a capability manager 1345 as described with reference to FIG. 13.

At 1710, the method may include outputting uplink grant information for a UE, the uplink grant information provides uplink resources for a set of multiple uplink transmission occasions, where reference signal bundling is enabled across two or more of the set of multiple uplink transmission occasions. The operations of 1710 may be performed in accordance with examples as disclosed herein. In some examples, aspects of the operations of 1710 may be performed by an uplink grant manager 1325 as described with reference to FIG. 13.

At 1715, the method may include obtaining a skipping indication that at least a second uplink transmission occasion of the set of multiple uplink transmission occasions will be unused by the UE, the second uplink transmission occasion subsequent to a first uplink transmission occasion that will be used for an uplink transmission. The operations of 1715 may be performed in accordance with examples as disclosed herein. In some examples, aspects of the operations of 1715 may be performed by a UTO manager 1330 as described with reference to FIG. 13.

At 1720, the method may include determining that the second uplink transmission occasion being unused breaks one or more of phase continuity or a power consistency across the set of multiple uplink transmission occasions. The operations of 1720 may be performed in accordance with examples as disclosed herein. In some examples, aspects of the operations of 1720 may be performed by a DMRS bundling manager 1335 as described with reference to FIG. 13.

At 1725, the method may include obtaining two or more uplink transmissions from the UE using at least the first uplink transmission occasion and a third uplink transmission occasion of the set of multiple uplink transmission occasions, where reference signals transmitted in the two or more uplink transmissions are unbundled based on at least the second uplink transmission occasion being unused. The operations of 1725 may be performed in accordance with examples as disclosed herein. In some examples, aspects of the operations of 1725 may be performed by a DMRS bundling manager 1335 as described with reference to FIG. 13.

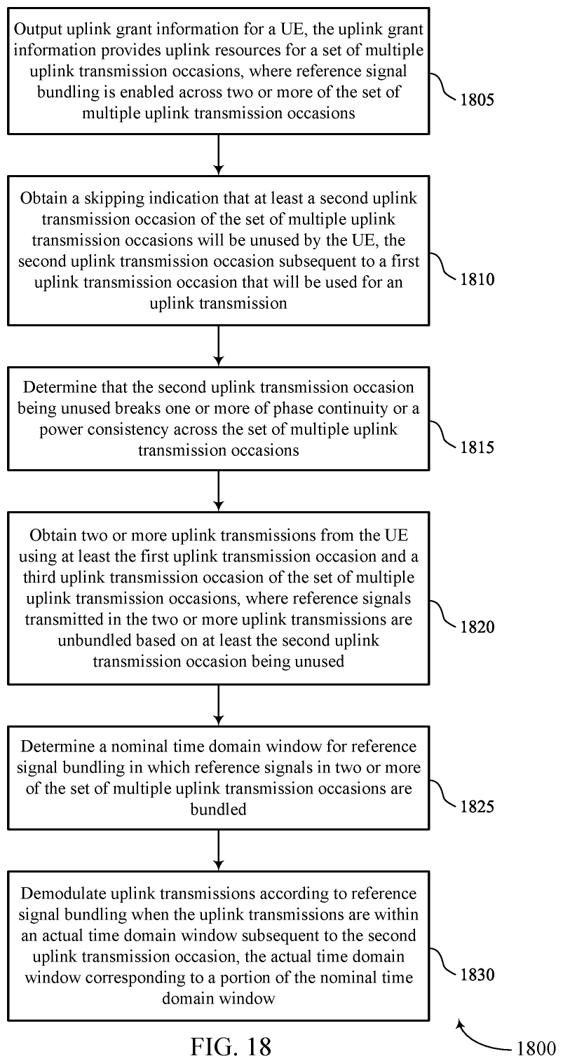

FIG. 18 shows a flowchart illustrating a method 1800 that supports techniques for demodulation reference signal bundling across unused transmission occasions in accordance with one or more aspects of the present disclosure. The operations of the method 1800 may be implemented by a network entity or its components as described herein. For example, the operations of the method 1800 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1805, the method may include outputting uplink grant information for a UE, the uplink grant information provides uplink resources for a set of multiple uplink transmission occasions, where reference signal bundling is enabled across two or more of the set of multiple uplink transmission occasions. The operations of 1805 may be performed in accordance with examples as disclosed herein. In some examples, aspects of the operations of 1805 may be performed by an uplink grant manager 1325 as described with reference to FIG. 13.

At 1810, the method may include obtaining a skipping indication that at least a second uplink transmission occasion of the set of multiple uplink transmission occasions will be unused by the UE, the second uplink transmission occasion subsequent to a first uplink transmission occasion that will be used for an uplink transmission. The operations of 1810 may be performed in accordance with examples as disclosed herein. In some examples, aspects of the operations of 1810 may be performed by a UTO manager 1330 as described with reference to FIG. 13.

At 1815, the method may include determining that the second uplink transmission occasion being unused breaks one or more of phase continuity or a power consistency across the set of multiple uplink transmission occasions. The operations of 1815 may be performed in accordance with examples as disclosed herein. In some examples, aspects of the operations of 1815 may be performed by a DMRS bundling manager 1335 as described with reference to FIG. 13.

At 1820, the method may include obtaining two or more uplink transmissions from the UE using at least the first uplink transmission occasion and a third uplink transmission occasion of the set of multiple uplink transmission occasions, where reference signals transmitted in the two or more uplink transmissions are unbundled based on at least the second uplink transmission occasion being unused. The operations of 1820 may be performed in accordance with examples as disclosed herein. In some examples, aspects of the operations of 1820 may be performed by a DMRS bundling manager 1335 as described with reference to FIG. 13.

At 1825, the method may include determining a nominal time domain window for reference signal bundling in which reference signals in two or more of the set of multiple uplink transmission occasions are bundled. The operations of 1825 may be performed in accordance with examples as disclosed herein. In some examples, aspects of the operations of 1825 may be performed by a time domain window manager 1340 as described with reference to FIG. 13.

At 1830, the method may include demodulating uplink transmissions according to reference signal bundling when the uplink transmissions are within an actual time domain window subsequent to the second uplink transmission occasion, the actual time domain window corresponding to a portion of the nominal time domain window. The operations of 1830 may be performed in accordance with examples as disclosed herein. In some examples, aspects of the operations of 1830 may be performed by a time domain window manager 1340 as described with reference to FIG. 13.

following provides an overview of aspects of the present disclosure:

Aspect 1: A method for wireless communications at a UE, comprising: receiving uplink grant information that provides uplink resources for a plurality of uplink transmission occasions, wherein reference signal bundling is enabled across two or more of the plurality of uplink transmission occasions; transmitting a skipping indication that at least a second uplink transmission occasion of the plurality of uplink transmission occasions will be unused by the UE, the second uplink transmission occasion subsequent to a first uplink transmission occasion that will be used for an uplink transmission; determining that the second uplink transmission occasion being unused breaks a phase continuity of uplink transmissions, a power consistency of uplink transmissions, or both, across the plurality of uplink transmission occasions; and transmitting two or more uplink transmissions using at least the first uplink transmission occasion and a third uplink transmission occasion of the plurality of uplink transmission occasions, wherein reference signals transmitted in the two or more uplink transmissions are unbundled based at least in part on at least the second uplink transmission occasion being unused.

Aspect 2: The method of aspect 1, wherein the skipping indication is included in a set of events that breaks one or more of phase continuity or a power consistency across the plurality of uplink transmission occasions.

Aspect 3: The method of any of aspects 1 through 2, further comprising: determining a nominal time domain window for reference signal bundling in which reference signals in two or more of the plurality of uplink transmission occasions are bundled; and restarting the reference signal bundling within an actual time domain window subsequent to the second uplink transmission occasion, the actual time domain window corresponding to a portion of the nominal time domain window.

Aspect 4: The method of any of aspects 1 through 3, wherein reference signal bundling is not restarted within a nominal time domain window for reference signal bundling in which reference signals in two or more of the plurality of uplink transmission occasions are bundled.

Aspect 5: The method of any of aspects 1 through 4, further comprising: determining a nominal time domain window for reference signal bundling in which reference signals in two or more of the plurality of uplink transmission occasions are bundled; and restarting the reference signal bundling within an actual time domain window subsequent to the second uplink transmission occasion when the skipping indication is transmitted prior to a threshold time period in advance of the second uplink transmission occasion, the actual time domain window corresponding to a portion of the nominal time domain window; or determining to not restart the reference signal bundling within the nominal time domain window when the skipping indication is transmitted after the threshold time period in advance of the second uplink transmission occasion.

Aspect 6: The method of any of aspects 1 through 5, further comprising: transmitting a capability indication that indicates whether the UE is capable of restarting the reference signal bundling subsequent to the skipping indication within a nominal time domain window.

Aspect 7: The method of any of aspects 1 through 6, wherein the uplink grant information provides periodic uplink resources for a series of time periods, and wherein two or more uplink transmission occasions are included in each time period of the series of time periods for two or more associated uplink shared channel transmissions according to a multi-grant uplink shared channel transmission configuration.

Aspect 8: The method of aspect 7, wherein the reference signal bundling is applied to transmit blocks that are transmitted over multiple slots, uplink shared channel transmission repetitions, and uplink shared channel transmissions according to the multi-grant uplink shared channel transmission configuration.

Aspect 9: The method of any of aspects 7 through 8, wherein the reference signal bundling is applied across two or more different transmit blocks transmitted in two or more of the plurality of uplink transmission occasions for uplink transmission of the multi-grant uplink shared channel transmission configuration.

Aspect 10: A method for wireless communications at a network entity, comprising: outputting uplink grant information for a UE, the uplink grant information provides uplink resources for a plurality of uplink transmission occasions, wherein reference signal bundling is enabled across two or more of the plurality of uplink transmission occasions; obtaining a skipping indication that at least a second uplink transmission occasion of the plurality of uplink transmission occasions will be unused by the UE, the second uplink transmission occasion subsequent to a first uplink transmission occasion that will be used for an uplink transmission; determining that the second uplink transmission occasion being unused breaks one or more of phase continuity or a power consistency across the plurality of uplink transmission occasions; and obtaining two or more uplink transmissions from the UE using at least the first uplink transmission occasion and a third uplink transmission occasion of the plurality of uplink transmission occasions, wherein reference signals transmitted in the two or more uplink transmissions are unbundled based at least in part on at least the second uplink transmission occasion being unused.

Aspect 11: The method of aspect 10, wherein the skipping indication is included in a set of events that breaks one or more of phase continuity or a power consistency across the plurality of uplink transmission occasions.

Aspect 12: The method of any of aspects 10 through 11, further comprising: determining a nominal time domain window for reference signal bundling in which reference signals in two or more of the plurality of uplink transmission occasions are bundled; and demodulating uplink transmissions according to reference signal bundling when the uplink transmissions are within an actual time domain window subsequent to the second uplink transmission occasion, the actual time domain window corresponding to a portion of the nominal time domain window.

Aspect 13: The method of any of aspects 10 through 12, wherein reference signal bundling is not restarted within a nominal time domain window for reference signal bundling in which reference signals in two or more of the plurality of uplink transmission occasions are bundled.

Aspect 14: The method of any of aspects 10 through 13, further comprising: determining a nominal time domain window for reference signal bundling in which reference signals in two or more of the plurality of uplink transmission occasions are bundled; and demodulating uplink transmissions according to reference signal bundling within an actual time domain window subsequent to the second uplink transmission occasion when the skipping indication is obtained prior to a threshold time period in advance of the second uplink transmission occasion, the actual time domain window corresponding to a portion of the nominal time domain window; or demodulating uplink transmissions according to unbundled reference signals within the nominal time domain window when the skipping indication is obtained after the threshold time period in advance of the second uplink transmission occasion.

Aspect 15: The method of any of aspects 10 through 14, further comprising: obtaining, from the UE, a capability indication that indicates whether the UE is capable of restarting the reference signal bundling subsequent to the skipping indication within a nominal time domain window.

Aspect 16: The method of any of aspects 10 through 15, wherein the uplink grant information provides periodic uplink resources for a series of time periods, and wherein two or more uplink transmission occasions are included in each time period of the series of time periods for two or more associated uplink shared channel transmissions according to a multi-grant uplink shared channel transmission configuration.

Aspect 17: The method of aspect 16, wherein the reference signal bundling is applied to transmit blocks that are transmitted over multiple slots, uplink shared channel transmission repetitions, and uplink shared channel transmissions according to the multi-grant uplink shared channel transmission configuration.

Aspect 18: The method of any of aspects 16 through 17, wherein the reference signal bundling is applied across two or more different transmit blocks transmitted in two or more of the plurality of uplink transmission occasions for uplink transmission of the multi-grant uplink shared channel transmission configuration.

Aspect 19: A UE for wireless communications, comprising one or more memories storing processor-executable code, and one or more processors coupled with the one or more memories and individually or collectively operable to execute the code to cause the UE to perform a method of any of aspects 1 through 9.

Aspect 20: A UE for wireless communications, comprising at least one means for performing a method of any of aspects 1 through 9.

Aspect 21: A non-transitory computer-readable medium storing code for wireless communications, the code comprising instructions executable by one or more processors to perform a method of any of aspects 1 through 9.

Aspect 22: A network entity for wireless communications, comprising one or more memories storing processor-executable code, and one or more processors coupled with the one or more memories and individually or collectively operable to execute the code to cause the network entity to perform a method of any of aspects 10 through 18.

Aspect 23: A network entity for wireless communications, comprising at least one means for performing a method of any of aspects 10 through 18.

Aspect 24: A non-transitory computer-readable medium storing code for wireless communications, the code comprising instructions executable by one or more processors to perform a method of any of aspects 10 through 18.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive uplink grant information that provides uplink resources for a plurality of uplink transmission occasions, wherein reference signal bundling is enabled across two or more of the plurality of uplink transmission occasions;
transmit a skipping indication that at least a second uplink transmission occasion of the plurality of uplink transmission occasions will be unused by the UE, the second uplink transmission occasion subsequent to a first uplink transmission occasion that will be used for an uplink transmission;
determine that the second uplink transmission occasion being unused breaks a phase continuity of uplink transmissions, a power consistency of uplink transmissions, or both, across the plurality of uplink transmission occasions; and
transmit two or more uplink transmissions using at least the first uplink transmission occasion and a third uplink transmission occasion of the plurality of uplink transmission occasions, wherein reference signals transmitted in the two or more uplink transmissions are unbundled based at least in part on at least the second uplink transmission occasion being unused.

2. The UE of claim 1, wherein the skipping indication is included in a set of events that breaks one or more of phase continuity or a power consistency across the plurality of uplink transmission occasions.

3. The UE of claim 1, wherein the one or more processors are individually or collectively further operable to execute the code to cause the UE to:
determine a nominal time domain window for reference signal bundling in which reference signals in two or more of the plurality of uplink transmission occasions are bundled; and
restart the reference signal bundling within an actual time domain window subsequent to the second uplink transmission occasion, the actual time domain window corresponding to a portion of the nominal time domain window.

4. The UE of claim 1, wherein reference signal bundling is not restarted within a nominal time domain window for reference signal bundling in which reference signals in two or more of the plurality of uplink transmission occasions are bundled.

5. The UE of claim 1, wherein the one or more processors are individually or collectively further operable to execute the code to cause the UE to:
determine a nominal time domain window for reference signal bundling in which reference signals in two or more of the plurality of uplink transmission occasions are bundled; and
restart the reference signal bundling within an actual time domain window subsequent to the second uplink transmission occasion when the skipping indication is transmitted prior to a threshold time period in advance of the second uplink transmission occasion, the actual time domain window corresponding to a portion of the nominal time domain window; or
determine to not restart the reference signal bundling within the nominal time domain window when the skipping indication is transmitted after the threshold time period in advance of the second uplink transmission occasion.

6. The UE of claim 1, wherein the one or more processors are individually or collectively further operable to execute the code to cause the UE to:
transmit a capability indication that indicates whether the UE is capable of restarting the reference signal bundling subsequent to the skipping indication within a nominal time domain window.

7. The UE of claim 1, wherein the uplink grant information provides periodic uplink resources for a series of time periods, and wherein two or more uplink transmission occasions are included in each time period of the series of time periods for two or more associated uplink shared channel transmissions according to a multi-grant uplink shared channel transmission configuration.

8. The UE of claim 7, wherein the reference signal bundling is applied to transmit blocks that are transmitted over multiple slots, uplink shared channel transmission repetitions, and uplink shared channel transmissions according to the multi-grant uplink shared channel transmission configuration.

9. The UE of claim 7, wherein the reference signal bundling is applied across two or more different transmit blocks transmitted in two or more of the plurality of uplink transmission occasions for uplink transmission of the multi-grant uplink shared channel transmission configuration.

10. A network entity, comprising:
one or more memories storing processor-executable code; and
one or more processors coupled with the one or more memories and individually or collectively operable to execute the code to cause the network entity to:
output uplink grant information for a user equipment (UE), the uplink grant information provides uplink resources for a plurality of uplink transmission occasions, wherein reference signal bundling is enabled across two or more of the plurality of uplink transmission occasions;
obtain a skipping indication that at least a second uplink transmission occasion of the plurality of uplink transmission occasions will be unused by the UE, the second uplink transmission occasion subsequent to a first uplink transmission occasion that will be used for an uplink transmission;
determine that the second uplink transmission occasion being unused breaks one or more of phase continuity or a power consistency across the plurality of uplink transmission occasions; and
obtain two or more uplink transmissions from the UE using at least the first uplink transmission occasion and a third uplink transmission occasion of the plurality of uplink transmission occasions, wherein reference signals transmitted in the two or more uplink transmissions are unbundled based at least in part on at least the second uplink transmission occasion being unused.

11. The network entity of claim 10, wherein the skipping indication is included in a set of events that breaks one or more of phase continuity or a power consistency across the plurality of uplink transmission occasions.

12. The network entity of claim 10, wherein the one or more processors are individually or collectively further operable to execute the code to cause the network entity to:
determine a nominal time domain window for reference signal bundling in which reference signals in two or more of the plurality of uplink transmission occasions are bundled; and
demodulate uplink transmissions according to reference signal bundling when the uplink transmissions are within an actual time domain window subsequent to the second uplink transmission occasion, the actual time domain window corresponding to a portion of the nominal time domain window.

13. The network entity of claim 10, wherein reference signal bundling is not restarted within a nominal time domain window for reference signal bundling in which reference signals in two or more of the plurality of uplink transmission occasions are bundled.

14. The network entity of claim 10, wherein the one or more processors are individually or collectively further operable to execute the code to cause the network entity to:
determine a nominal time domain window for reference signal bundling in which reference signals in two or more of the plurality of uplink transmission occasions are bundled; and
demodulate uplink transmissions according to reference signal bundling within an actual time domain window subsequent to the second uplink transmission occasion when the skipping indication is obtained prior to a threshold time period in advance of the second uplink transmission occasion, the actual time domain window corresponding to a portion of the nominal time domain window; or
demodulate uplink transmissions according to unbundled reference signals within the nominal time domain window when the skipping indication is obtained after the threshold time period in advance of the second uplink transmission occasion.

15. The network entity of claim 10, wherein the one or more processors are individually or collectively further operable to execute the code to cause the network entity to:
obtain, from the UE, a capability indication that indicates whether the UE is capable of restarting the reference signal bundling subsequent to the skipping indication within a nominal time domain window.

16. The network entity of claim 10, wherein the uplink grant information provides periodic uplink resources for a series of time periods, and wherein two or more uplink transmission occasions are included in each time period of the series of time periods for two or more associated uplink shared channel transmissions according to a multi-grant uplink shared channel transmission configuration.

17. The network entity of claim 16, wherein the reference signal bundling is applied to transmit blocks that are transmitted over multiple slots, uplink shared channel transmission repetitions, and uplink shared channel transmissions according to the multi-grant uplink shared channel transmission configuration.

18. The network entity of claim 16, wherein the reference signal bundling is applied across two or more different transmit blocks transmitted in two or more of the plurality of uplink transmission occasions for uplink transmission of the multi-grant uplink shared channel transmission configuration.

19. A method for wireless communications at a user equipment (UE), comprising:
receiving uplink grant information that provides uplink resources for a plurality of uplink transmission occasions, wherein reference signal bundling is enabled across two or more of the plurality of uplink transmission occasions;
transmitting a skipping indication that at least a second uplink transmission occasion of the plurality of uplink transmission occasions will be unused by the UE, the second uplink transmission occasion subsequent to a first uplink transmission occasion that will be used for an uplink transmission;
determining that the second uplink transmission occasion being unused breaks a phase continuity of uplink transmissions, a power consistency of uplink transmissions, or both, across the plurality of uplink transmission occasions; and
transmitting two or more uplink transmissions using at least the first uplink transmission occasion and a third uplink transmission occasion of the plurality of uplink transmission occasions, wherein reference signals transmitted in the two or more uplink transmissions are unbundled based at least in part on at least the second uplink transmission occasion being unused.

20. The method of claim 19, wherein the skipping indication is included in a set of events that breaks one or more of phase continuity or a power consistency across the plurality of uplink transmission occasions.
